(19) United States
(12) Patent Application Publication
(10) Pub. No.: US 2019/0299797 A1
(43) Pub. Date: Oct. 3, 2019

(54) ELECTRIC ASSISTANCE SYSTEM AND ELECTRICALLY ASSISTED VEHICLE

(71) Applicant: YAMAHA HATSUDOKI KABUSHIKI KAISHA, Shizuoka (JP)

(72) Inventor: Mitsuharu HASUMI, Shizuoka (JP)

(21) Appl. No.: 16/443,923

(22) Filed: Jun. 18, 2019

Related U.S. Application Data
(63) Continuation of application No. PCT/JP2017/034147, filed on Sep. 21, 2017.

(30) Foreign Application Priority Data
Dec. 28, 2016 (JP) 2016-255871

(51) Int. Cl. B60L 15/20; B60L 50/20; B62M 6/45

(52) U.S. Cl. CPC B60L 15/2054; B60L 15/2036; B60L 2240/423; B62M 6/45; B60L 2240/421; B60L 50/20

(57) ABSTRACT

An electric assistance system used in an electrically assisted vehicle provided with a pedal includes a crankshaft rotatable by human power of a rider applied to the pedal, a torque sensor that outputs a torque signal in accordance with a magnitude of a torque generated at the crankshaft, an electric motor that generates an assist power that assists the human power of the rider, an acceleration sensor that outputs an acceleration signal in accordance with a current acceleration in a travel direction of the electric assist vehicle, and a controller that receives the torque signal and the acceleration signal and determines a magnitude of the assist power to be generated by the electric motor. The controller calculates a target acceleration from the torque signal based on a rule prepared in advance, and determines the magnitude of the assist power to be generated by the electric motor such that a deviation between the target acceleration and the current acceleration is decreased.

### BACKGROUND OF THE INVENTION

### 1. Field of the Invention

The present invention relates to an electric assist system usable for an electric assist vehicle, and an electric assist vehicle including the electric assist system.

### 2. Description of the Related Art

An electric assist bicycle, by which power of a rider pedaling the bicycle is assisted by an electric motor, is known. In such an electric assist bicycle, assist power in accordance with human power applied by the rider to a pedal is generated by the electric motor, and a motive power as a sum of the human power and the assist power is transmitted to a driving wheel. The human power may be assisted by the electric motor, so that the burden on the rider is alleviated (e.g., Japanese Laid-Open Patent Publication No. 09-226664).

The rider pedals an electric assist bicycle, and as a result, the electric assist bicycle is accelerated, runs at a constant speed, or is decelerated.

In the case in which the human power applied to the pedal of the electric assist bicycle is kept the same, as the load on the vehicle is increased, the change ratio (acceleration) of the vehicle speed is decreased. For example, in the case in which the human power applied to the pedal is kept the same, the change ratio (acceleration) of the vehicle speed is lower while the vehicle is running on a slope than while the vehicle is running on a flat road. The rider may feel inconvenient that the change ratio (acceleration) of the vehicle speed changes despite that the rider keeps on rotating the pedal with the same force.

### SUMMARY OF THE INVENTION

Preferred embodiments of the present invention provide electric assist systems that generate an appropriate magnitude of assist power in accordance with a load while an electric assist vehicle is running, and electric assist vehicles including the electric assist system.

An electric assist system according to a preferred embodiment of the present invention is usable for an electric assist vehicle including a pedal. The electric assist system includes a crankshaft rotatable by human power of a rider applied to the pedal; a torque sensor that outputs a torque signal in accordance with a magnitude of a torque generated at the crankshaft; an electric motor that generates an assist power that assists the human power of the rider; an acceleration sensor that outputs an acceleration signal in accordance with a current acceleration in a travel direction of the electric assist vehicle; and a controller configured or programmed to receive the torque signal and the acceleration signal and determine a magnitude of the assist power to be generated by the electric motor. The controller calculates a target acceleration from the torque signal based on a rule prepared in advance, and determines the magnitude of the assist power to be generated by the electric motor such that a deviation between the target acceleration and the current acceleration is decreased.

Because of the structure of the bicycle of allowing the rider to have his/her foot step on, and rotate, the pedal, the magnitude of the human power of the rider applied to the pedal changes in accordance with the position of the pedal while the rider is rotating the pedal. Therefore, the acceleration in the travel direction of the electric assist bicycle changes in accordance with the position of the pedal while the rider is rotating the pedal. The electric assist system changes the magnitude of the assist power to be generated by the electric motor such that the deviation between the target acceleration determined from the pedal force of the rider and the current acceleration of the vehicle is decreased. Even if a load is applied during running, the pedal force of the rider is considered to represent the sense of acceleration desired by the rider. Therefore, the target acceleration is set based on the pedal force, and the current acceleration of the vehicle is controlled to be closer to the target acceleration. With such an arrangement, the rider may run the electric assist vehicle with an appropriate magnitude of assist power in accordance with the load during running.

In a preferred embodiment of the present invention, the controller is configured or programmed to perform PID control to determine the magnitude of the assist power to be generated by the electric motor and thus to decrease the deviation.

In a preferred embodiment of the present invention, when a current deviation at current time t is represented as E(t), and feedback gains of a proportional element, a differential element and an integration element of the assist power control system are respectively represented as Kp, Kd and Ki, the controller may determine a motor torque Fm, corresponding to the assist power to be generated by the electric motor, by the following expression:

$$Fm ( t ) = Kp \times e ( t ) + Ki \times {\int }_{0}^{t} e ( τ ) d τ + Kd \times \frac{de ( t )}{dt} . \qquad Expression 1$$

In a preferred embodiment of the present invention, the controller may determine the magnitude of the assist power to be generated by the electric motor such that the deviation is closer to 0.

In any of the above-described preferred embodiments, the ability to make the acceleration closer to the target acceleration may be improved.

In a preferred embodiment of the present invention, the controller is configured or programmed to store, in advance, a table associating a command value of an electric current that is to flow in the electric motor and a magnitude of a motor torque corresponding to the assist power to be generated by the electric motor to each other, and refer to the table to determine the command value of the electric current required to generate the motor torque.

In a preferred embodiment of the present invention, the controller is configured or programmed to store, in advance, a table associating a command value of an electric current that is to flow in the electric motor and a magnitude of a motor torque to each other for each of ranges of magnitudes of the deviation, and refer to the table to determine the command value of the electric current required to generate the motor torque.

In a preferred embodiment of the present invention, when a current deviation at current time t is represented as E(t), and feedback gains usable to determine a command value of an electric current from a proportion term, an integration term and a differential term regarding a residual deviation are respectively represented as Kp′, Kd′ and Ki′, the controller is configured or programmed to determine the command value Im, for the electric current that is to flow in the electric motor, by the following expression:

$$Im ( t ) = {Kp}^{′} \times e ( t ) + {Ki}^{′} \times {\int }_{0}^{t} e ( τ ) d τ + {Kd}^{′} \times \frac{de ( t )}{dt} . \qquad Expression 2$$

In a preferred embodiment of the present invention, the controller includes a storage that stores the rule prepared in advance.

In a preferred embodiment of the present invention, the rule may be a map or a function defining the correspondence between the torque signal and the target acceleration.

In a preferred embodiment of the present invention, the function may be a nonlinear function or a linear function.

In a preferred embodiment of the present invention, the controller includes a high-pass filter that transmits a high-frequency component of a predefined frequency or higher that is included in the received acceleration signal.

In a preferred embodiment of the present invention, the controller includes a high-pass filter that transmits a high-frequency component of 5 Hz or higher.

The high-pass filter may be provided so that the acceleration generated by the rider rotating the pedal is appropriately extracted.

In a preferred embodiment of the present invention, during a time period in which the rider rotates the pedal to make one rotation of the crankshaft, the torque sensor and the acceleration sensor respectively output a torque signal and an acceleration signal a plurality of times or continuously, and the controller is configured or programmed to determine the magnitude of the assist power to be generated by the electric motor a plurality of times or temporally continuously.

In a preferred embodiment of the present invention, during a time period in which the rider rotates the pedal to make one rotation of the crankshaft, the torque signal changes in accordance with the rotation of the crankshaft that is associated with an operation of the rider rotating the pedal, the acceleration signal changes in accordance with the operation of the rider rotating the pedal and an external disturbance applied to the electric assist vehicle, and the controller is configured or programmed to calculate the target acceleration from the torque signal, calculate the acceleration from the acceleration signal, and determine the magnitude of the assist power to be generated by the electric motor at a predefined timing.

In a preferred embodiment of the present invention, the electric assist system further includes a motor driving circuit that outputs, to the electric motor, an electric current including at least one of an amplitude, a frequency and a flow direction controlled in accordance with a command value. The controller is configured or programmed to output, to the motor driving circuit, a command value that causes an electric current that is in accordance with the determined magnitude of the assist power to flow. With such an arrangement, an appropriate magnitude of assist power may be generated such that the target acceleration in accordance with the pedal force during running is obtained.

An electric assist vehicle according to an illustrative preferred embodiment of the present invention includes the above-described electric assist system. In a preferred embodiment of the present invention, the electric assist vehicle includes a front wheel and a rear wheel, and a power transmission mechanism that transmits the human power of the rider and the assist power to the rear wheel. The electric assist vehicle including the electric assist system according to an illustrative preferred embodiment of the present invention may generate an appropriate magnitude of assist power such that the target acceleration in accordance with the pedal force during running is obtained.

According to an illustrative preferred embodiment of the present invention, the magnitude of the assist power to be generated by the electric motor is changed such that the deviation between the target acceleration determined from the pedal force of the rider and the current acceleration is decreased. Even if a load is applied during running, the pedal force of the rider is considered to represent the sense of acceleration desired by the rider. Therefore, the target acceleration is set based on the pedal force, and the current acceleration of the vehicle is controlled to be made closer to the target acceleration. With such an arrangement, the rider may run the electric assist vehicle with an appropriate magnitude of assist power in accordance with the load during running.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view showing an electric assist bicycle according to a preferred embodiment of the present invention.

FIG. 2A is a hardware block diagram of the electric assist bicycle.

FIG. 2B is a block diagram showing a mechanical structure of the electric assist bicycle.

FIG. 3 is an external view of an operation panel.

FIG. 4 shows the relationship among the rotation angle of a crankshaft, the torque generated at the crankshaft and the acceleration in a travel direction of the vehicle.

FIG. 5A shows an operation of decreasing a deviation En between a target acceleration and a current acceleration of the vehicle to generate assist power in accordance with a running load (headwind).

FIG. 5B shows an operation of decreasing the deviation En between the target acceleration and the current acceleration of the vehicle to generate assist power in accordance with a running load (ascending slope).

FIG. 6 shows the relationship between a pedal force provided by the human (torque signal) and the target acceleration.

FIG. 7 shows the relationship between the pedal force provided by the human (torque signal) and the target acceleration defined for each of N pieces of selectable assist modes.

FIG. 8 is a flowchart showing a procedure of a process performed by a controller 70.

FIG. 9 shows waveforms of various signals when a load change occurs while the rider is pedaling the electric assist bicycle 1 in a certain pedaling manner.

FIG. 10 shows waveforms of various signals when a load change occurs while the rider is pedaling the electric assist bicycle 1 in the certain pedaling manner.

FIG. 11A is a static load correlation diagram of the electric assist bicycle 1 on a flat road.

FIG. 11B is a static load correlation diagram of the electric assist bicycle 1 on a slope having an inclination angle θ.

FIG. 12 shows a target acceleration (solid line) in the case in which a low-frequency component is not removed by a high-pass filter 73.

FIG. 13 shows a motor torque in accordance with the magnitude of the deviation in the acceleration.

### DETAILED DESCRIPTION OF THE PREFERRED EMBODIMENTS

Hereinafter, electric assist systems and electric assist vehicles according to preferred embodiments of the present invention will be described with reference to the attached drawings. In the description of the preferred embodiments, like elements will bear like reference signs, and overlapping descriptions will be omitted. In the preferred embodiments of the present invention, the terms front, rear, left, right, up and down respectively refer to front, rear, left, right, up and down as seen from a rider, of the electric assist vehicle, sitting on a saddle (seat) as facing a handle. The following preferred embodiments are examples, and the present invention is not limited to any of the following preferred embodiments.

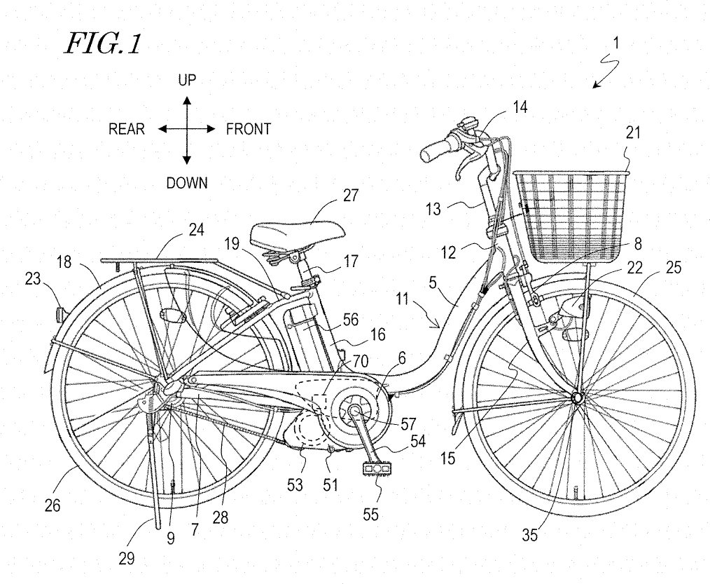

FIG. 1 is a side view showing an electric assist bicycle 1 according to a preferred embodiment of the present invention. The electric assist bicycle 1 includes a driving unit 51 described in detail below. The electric assist bicycle 1 is an example of electric assist vehicle according to a preferred embodiment of the present invention. The driving unit 51 is an example of an electric assist system according to a preferred embodiment of the present invention.

The electric assist bicycle 1 includes a vehicle frame 11 extending in a front-rear direction. The vehicle frame 11 includes a head pipe 12, a down tube 5, a bracket 6, a chain stay 7, a seat tube 16, and a seat stay 19. The head pipe 12 is located at a front end of the vehicle frame 11. A handle stem 13 is rotatably inserted into the head pipe 12. A handle 14 is secured to a top end of the handle stem 13. A front fork 15 is secured to a bottom end of the handle stem 13. A front wheel 25, which is a steering wheel, is rotatably supported at a bottom end of the front fork 15. The front fork 15 is provided with a brake 8 that brakes the front wheel 25. A front basket 21 is provided on the front of the head pipe 12. The front fork 15 is provided with a head lamp 22.

The down tube 5 extends obliquely rearward and downward from the head pipe 12. The seat tube 16 extends upward from a rear end of the down tube 5. The chain stay 7 extends rearward from a bottom end of the seat tube 16. The bracket 6 connects the rear end of the down tube 5, the bottom end of the seat tube 16 and a front end of the chain stay 7 to each other.

A seat post 17 is inserted into the seat tube 16, and a saddle 27, on which a rider is to sit, is provided at a top end of the seat post 17. A rear portion of the chain stay 7 supports a rear wheel 26, which is a driving wheel, such that the rear wheel 26 is rotatable. A brake 9 that brakes the rear wheel 26 is provided to the rear of the chain stay 7. A stand 29 is provided to the rear of the chain stay 7. While being parked, the electric assist bicycle 1 is held standing by the stand 29. The seat stay 19 extends obliquely rearward and downward from a top portion of the seat tube 16. A bottom end of the seat stay 19 is connected with the rear portion of the chain stay 7. The seat stay 19 supports a rack 24 provided to the rear of the saddle 27 and also supports a fender 18 covering a top portion of the rear wheel 26. A tail lamp 23 is provided to the rear of the fender 18.

The bracket 6, which is located on the vehicle frame 11, at a position in the vicinity of the center of the vehicle, is provided with the driving unit 51. The driving unit 51 includes an electric motor 53, a crankshaft 57, and a controller 70. A battery 56 that supplies power to the electric motor 53 and the like is mounted on the bracket 6. The battery 56 may be supported by the seat tube 16.

The crankshaft 57 is supported throughout the driving unit 51 in a left-right direction. Crank arms 54 are provided at both of two ends of the crankshaft 57. A pedal 55 is rotatably provided at a tip of each of the crank arms 54.

The controller 70 controls an operation of the electric assist bicycle 1. The controller 70 typically includes a semiconductor integrated circuit, such as a microcontroller, a signal processor or the like, that is configured or programmed to process digital signals. A rotation output of the crankshaft 57 generated when the rider steps on, and rotates, the pedal 55 with his/her foot is transmitted to the rear wheel 26 via a chain 28. The controller 70 controls the electric motor 53 to generate a driving assist output in accordance with the rotation output of the crankshaft 57. The assist power generated by the electric motor 53 is transmitted to the rear wheel 26 via the chain 28. Instead of the chain 28, a belt, a shaft or the like may be used.

Now, a specific structure of the controller 70, and a group of sensors that generate a signal usable to operate the controller 70, will be described in detail.

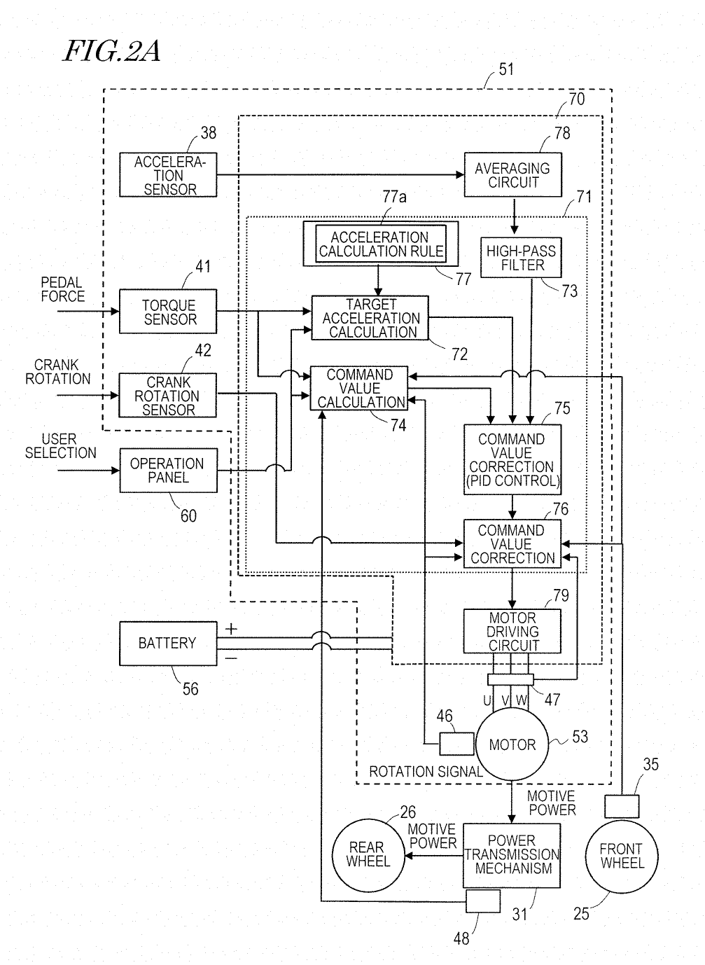

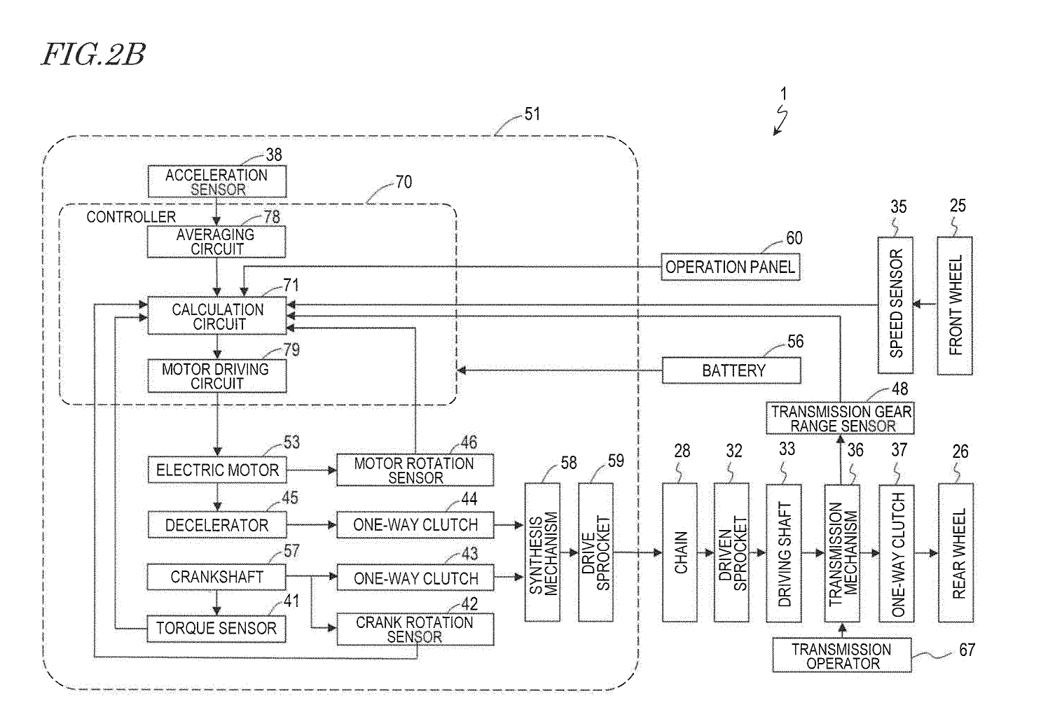

FIG. 2A is a hardware block diagram of the electric assist bicycle 1, mainly showing a structure of the controller 70. FIG. 2A also shows the controller 70 and a peripheral environment thereof. In the peripheral environment, for example, various sensors that output a signal to the controller 70 and the driving motor 53 driven as a result of the operation of the controller 70 are shown.

First, the peripheral environment of the controller 70 will be described.

As described above, the controller 70 is included in the driving unit 51. FIG. 2A shows an acceleration sensor 38, a torque sensor 41, a crank rotation sensor 42, and the electric motor 53, which are also included in the driving unit 51. The controller 70 includes a calculation circuit 71, an averaging circuit 78, and a motor driving circuit 79. The calculation circuit 71 receives a torque signal and calculates a target acceleration from the torque signal based on a rule prepared in advance. Thus, the calculation circuit 71 performs a calculation to determine the magnitude of the assist power to be generated by the electric motor such that a deviation between the target acceleration and a current acceleration is decreased, and outputs a control signal.

The acceleration sensor 38 detects an acceleration of a vehicle main body of the electric assist bicycle 1. The acceleration sensor 38 is, for example, a three-axis acceleration sensor of a piezo resistance type, an electrostatic capacitance type, or a heat sensing type. One such three-axis acceleration sensor is capable of measuring the acceleration in each of three axial directions perpendicular to each other (X-axis, Y-axis and Z-axis directions). An acceleration signal may be a voltage signal in accordance with the magnitude of the acceleration. The acceleration sensor 38 may include an acceleration calculation circuit (not shown) converting the voltage signal into an acceleration value. The acceleration calculation circuit converts, for example, an output analog voltage signal into a digital voltage signal, and calculates the acceleration from the magnitude of the digital voltage signal.

In this specification, a signal that is output from the acceleration sensor 38 and represents the detected acceleration is referred to as an “acceleration signal”. The acceleration signal may be either an analog voltage signal or a digital voltage signal. The acceleration sensor 38 may output an acceleration signal as a non-discrete, continuous signal, or may output an acceleration signal as a discrete signal representing the acceleration detected at a predetermined cycle (e.g., at a cycle of 0.1 seconds).

In this specification, the three axial directions perpendicular to each other (X-axis, Y-axis, and Z-axis directions) do not represent an absolute coordinate system but represent a relative coordinate system. More specifically, the three axial directions perpendicular to each other (X-axis, Y-axis and Z-axis directions) are respectively the front-rear direction, the left-right direction, and an up-down direction of the electric assist bicycle 1 including the acceleration sensor 38. The forward direction of the electric assist bicycle 1 matches a travel direction thereof, and the up-down direction of the electric assist bicycle 1 matches a direction perpendicular to a road surface. Therefore, the X axis, the Y axis and the Z axis of the electric assist bicycle 1 running on a flat road may not match the X axis, the Y axis and the Z axis of the electric assist bicycle 1 running on a slope.

The three-axis acceleration sensor is an example of the acceleration sensor 38. A two-axis acceleration sensor capable of measuring an acceleration Gx in the X-axis direction and an acceleration Gz in the Z-axis direction may be used as the acceleration sensor 38. A monoaxial acceleration sensor capable of measuring the acceleration Gx in the X-axis direction may be used as the acceleration sensor 38. The acceleration sensor 38 merely needs to be capable of measuring at least the acceleration Gx in the X-axis direction along the travel direction of the vehicle. A plurality of acceleration sensors may be used to detect accelerations in different axial directions respectively. In the example shown in FIG. 2A, the acceleration sensor 38 is located in the driving unit 51. The position of the acceleration sensor 38 is not limited to this, and the acceleration sensor 38 may be located at any position in the electric assist bicycle 1.

The torque sensor 41 detects the human power (pedal force), applied by the rider to each of the pedals 55, as a torque generated at the crankshaft 57. The torque sensor 41 is, for example, a magnetostrictive torque sensor. The torque sensor 41 outputs a voltage signal having an amplitude of the magnitude in accordance with the detected torque. The torque sensor 41 may include a torque calculation circuit (not shown) that converts the voltage signal into a torque. The torque calculation circuit converts, for example, an output analog voltage signal into a digital voltage signal, and calculates the torque from the magnitude of the digital voltage signal.

In this specification, a signal that is output from the torque sensor 41 and represents the detected torque is referred to as a “torque signal”. The torque signal may be either an analog voltage signal or a digital voltage signal. The torque sensor 41 may output a torque signal as a non-discrete, continuous signal, or may output a torque signal as a discrete signal representing the torque detected at a predetermined cycle (e.g., at a cycle of 0.1 seconds).

The crank rotation sensor 42 detects a rotation angle of the crankshaft 57. For example, the crank rotation sensor 42 detects the rotation of the crankshaft 57 at every predetermined angle and outputs a rectangular wave signal or a sine wave signal. The output signal may be used to calculate a rotation angle and a rotation speed of the crankshaft 57. For example, a plurality of magnetic bodies having magnetic poles (N pole, S pole) are located around the crankshaft 57. A Hall sensor located at a fixed position converts a change in the magnetic field polarity caused by the rotation of the crankshaft 57 into a voltage signal. The controller 70 uses the signal that is output from the Hall sensor to count the changes in the magnetic field polarity and calculates the rotation angle and the rotation speed of the crankshaft 57. The crank rotation sensor 42 may include a calculation circuit that calculates the rotation angle and the rotation speed of the crankshaft 57 from the output signal.

The motor driving circuit 79 is, for example, an inverter. The motor driving circuit 79 supplies, from the battery 56 to the electric motor 53, an electric current having an amplitude, a frequency, a flow direction or the like in accordance with a motor electric current command value from the calculation circuit 71. The electric motor 53 supplied with the electric current rotates to generate assist power of a determined magnitude. The details of the motor driving circuit 79 will be described below.

The rotation of the electric motor 53 is detected by a motor rotation sensor 46. The motor rotation sensor 46 is, for example, a Hall sensor, and detects the magnetic field generated by a rotor (not shown) of the electric motor 53 while the rotor is rotating and outputs a voltage signal in accordance with the strength or the polarity of the magnetic field. In the case in which the electric motor 53 is a brushless DC motor, a plurality of permanent magnets are located in the rotor. The motor rotation sensor 46 converts a change in the magnetic field polarity caused by the rotation of the rotor into a voltage signal. The calculation circuit 71 uses the signal that is output from the motor rotation sensor 46 to count the changes in the magnetic field polarity, and calculates the rotation angle and the rotation speed of the rotor.

The assist power generated by the electric motor 53 is transmitted to the rear wheel 26 via the power transmission mechanism 31. The power transmission mechanism 31 includes a group of components including the chain 28, a driven sprocket 32, a driving shaft 33, a transmission mechanism 36, a one-way clutch 37, a decelerator (not shown) decelerating the rotation of the electric motor 53, a transmission (not shown) provided on the rear wheel 26, and the like described below with reference to FIG. 2B. With the above-described structure, the human power of the rider of the electric assist bicycle 1 is assisted.

The calculation circuit 71 receives a detection signal that is output from each of the acceleration sensor 38, the torque sensor 41 and the crank rotation sensor 42 and an operation signal that is output from the operation panel 60, and determines the magnitude of the assist power. The calculation circuit 71 transmits a motor electric current command value, based on which the assist power of the determined magnitude is to be generated, to the motor driving circuit 79. As a result, the electric motor 53 rotates, and the motive power of the electric motor 53 is transmitted to the rear wheel 26. In this manner, the motive power of the electric motor 53 is added to the human power of the rider.

The detection signal that is output from any of the various sensors is an analog signal. In general, an A/D conversion circuit (not shown) that converts an analog signal into a digital signal may be provided on a stage before the detection signal is input to the controller 70. The A/D conversion circuit may be provided in each of the sensors, or may be provided on a signal path, in the driving unit 51, between each of the sensors and the controller 70. Alternatively, the A/D conversion circuit may be provided in the controller 70.

The magnitude of the assist power to be generated by the electric motor 53 may change in accordance with an assist mode currently selected. The assist mode may be selected by the rider operating the operation panel 60.

The operation panel 60 is attached to the handle 14 (FIG. 1) of the electric assist bicycle 1 and is connected with the controller 70 by, for example, a wire cable. The operation panel 60 transmits an operation signal, representing the operation made by the rider, to the controller 70, and receives various information to be presented to the rider from the controller 70.

Now, a power transmission route in the electric assist bicycle 1 will be described. FIG. 2B is a block diagram showing an example of mechanical structure of the electric assist bicycle 1.

When the rider steps on the pedal 55 to rotate the crankshaft 57, the rotation of the crankshaft 57 is transmitted to the synthesis mechanism 58 via the one-way clutch 43. The rotation of the electric motor 53 is transmitted to the synthesis mechanism 58 via the decelerator 45 and the one-way clutch 44.

The synthesis mechanism 58 includes, for example, a cylindrical member, and the crankshaft 57 is located inside the cylindrical member. The drive sprocket 59 is attached to the synthesis mechanism 58. The synthesis mechanism 58 rotates centered around the same rotation shaft as that of the crankshaft 57 and the drive sprocket 59.

The one-way clutch 43 transmits a forward rotation of the crankshaft 57 to the synthesis mechanism 58, but does not transmits a reverse rotation of the crankshaft 57 to the synthesis mechanism 58. The one-way clutch 44 transmits, to the synthesis mechanism 58, a rotation of the electric motor 53 in such a direction as to rotate the synthesis mechanism 58 in a forward direction, but does not transmit, to the synthesis mechanism 58, a rotation of the electric motor 53 in such a direction as to rotate the synthesis mechanism 58 in a reverse direction. In the case in which the rider rotates the pedal 55 to rotate the synthesis mechanism 58 while the electric motor 53 is at a stop, the one-way clutch 44 does not transmit the rotation to the electric motor 53. The pedal force applied by the rider to the pedal 55 and the assist power generated by the electric motor 53 are transmitted to the synthesis mechanism 58 to be synthesized. The resultant force synthesized by the synthesis mechanism 58 is transmitted to the chain 28 via the drive sprocket 59.

The rotation of the chain 28 is transmitted to the driving shaft 33 via the driven sprocket 32. The rotation of the driving shaft 33 is transmitted to the rear wheel 26 via the transmission mechanism 36 and the one-way clutch 37.

The transmission mechanism 36 changes the transmission gear ratio in accordance with the operation of the rider made on a transmission operator 67. The transmission operator 67 is attached to, for example, the handle 14 (FIG. 1). In the case in which the rotation speed of the driving shaft 33 is higher than the rotation speed of the rear wheel 36, the one-way clutch 37 transmits the rotation of the driving shaft 33 to the rear wheel 26. In the case in which the rotation speed of the driving shaft 33 is lower than the rotation speed of the rear wheel 36, the one-way clutch 37 does not transmit the rotation of the driving shaft 33 to the rear wheel 26.

With the above-described power transmission route, the pedal force applied by the rider on the pedal 55 and the assist power generated by the electric motor 53 are transmitted to the rear wheel 26.

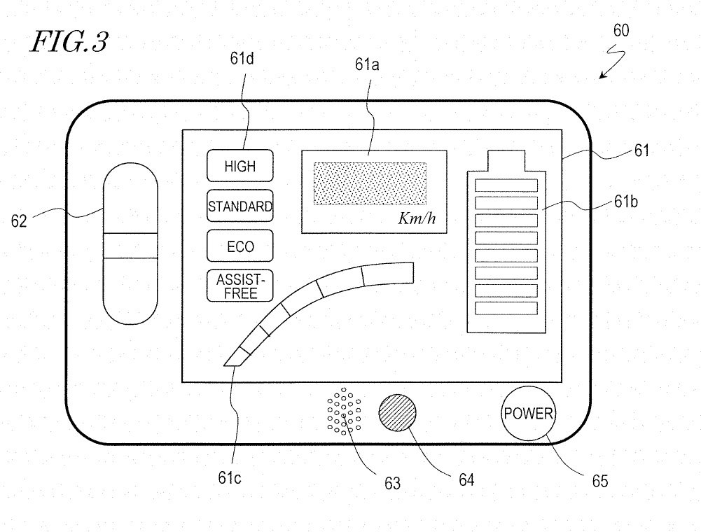

FIG. 3 is an illustrated external view of the operation panel 60. The operation panel 60 is attached to, for example, the handle 14, at a position close to a left grip thereof.

The operation panel 60 includes a display panel 61, an assist mode operation switch 62, and a power source switch 65.

The display panel 61 is, for example, a liquid crystal panel. The display panel 61 displays information provided by the controller 70 that includes the speed of the electric assist bicycle 1, the remaining capacitance of the battery 56, information on the range in which the assist ratio is to be changed, the assist mode, and other information on the running.

The display panel 61 includes a speed display area 61a, a battery remaining capacitance display area 61b, an assist ratio change range display area 61c, and an assist mode display area 61d. The display panel 61 acts as a notification device that notifies the rider of such information and the like. In this example, the information is displayed. Alternatively, an audio signal may be output to notify the rider of the information.

The speed display area 61a displays the vehicle speed of the electric assist bicycle 1 by numerical figures. In this preferred embodiment, the vehicle speed of the electric assist bicycle 1 is detected by a speed sensor 35 provided on the front wheel 25.

The battery remaining capacitance display area 61b displays the remaining capacitance of the battery 56 by segments based on information on the battery remaining capacitance that is output from the battery 56 to the controller 70. With such a display, the rider intuitively grasps the remaining capacitance of the battery 56.

The assist ratio change range display area 61c displays the range, set by the controller 70, in which the assist ratio is to be changed. The range is displayed by segments. The assist ratio, within the change ratio, that is currently used may also be displayed.

The assist mode display area 61d displays the assist mode selected by the rider operating the assist mode operation switch 62. The assist mode is, for example, “high”, “standard” or “automatic ecological”. In the case in which the rider operates the assist mode operation switch 62 to select “assist mode off”, the assist mode display area 61d displays “assist-free”.

The assist mode selection switch 62 enables the rider to select one of the plurality of assist modes (including “assist mode off”) described above. When one of the plurality of assist modes is selected, a microcontroller (not shown) provided inside the operation panel 60 transmits an operation signal, specifying the selected assist mode, to the controller 70.

The power source switch 65 is a switch by which the power source of the electric assist bicycle 1 is switched on or off. The rider presses the power source switch 65 to switch the power source of the electric assist bicycle 1 on or off.

The operation panel 60 further includes a speaker 63 that provides necessary information to the rider by an audio signal and a lamp 64 that provides necessary information to the rider by light. For example, the controller 70 changes the magnitude of the assist power to be generated by the electric motor 53 in accordance with the change in the acceleration, which is associated with the operation of the rider rotating the pedal 55. At this point, it is notified to the rider by, for example, the output of an audio signal and/or blinking of light, that the magnitude of the assist power has been changed. As a result of the notification, the rider recognizes that, for example, a large assist power has been generated.

Alternatively, the handle 14 and/or the saddle 27 may be vibrated to notify the rider that the magnitude of the assist power has been changed.

While the assist power is increasing, the speaker 63 may be caused to generate an audio signal of a volume that is heard by people around the electric assist bicycle 1, or the head lamp 22 and the tail lamp 23 may be lit up or blinked. With such an arrangement, the people around the electric assist bicycle 1 recognize that the electric assist bicycle 1 is generating assist power larger than the usual assist power.

The assist power of the electric motor 53 is largest in the “high” mode, is smallest in the “automatic ecological” mode, and is medium in the “standard” mode in response to the crank rotation output.

In the case in which the assist mode is “standard”, the electric motor 53 generates an assist power when, for example, the electric assist bicycle 1 is to start, is running on a flat road, or is running on an ascending slope. In the case in which the assist mode is “high”, the electric motor 53 generates an assist power when, for example, the electric assist bicycle 1 is to start, is running on a flat road, or is running on an ascending slope, like in the case in which the assist mode is “standard”. In the case in which the assist mode is “high”, the electric motor 53 generates larger assist power than in the case in which the assist mode is “standard” in response to the same crank rotation output. In the case in which the assist mode is “automatic ecological”, when, for example, the electric assist bicycle 1 is to start on a flat road, the electric motor 53 generates an assist power smaller than that in the case in which the assist mode is “standard”, and when the electric assist bicycle 1 is running on an ascending slope, the electric motor 53 generates an assist power larger than that in the case in which the assist mode is “standard”. When the pedal force is small because the electric assist bicycle 1 is, for example, running on a flat road or on a descending slope, the electric motor 53 decreases the assist power as compared with in the case in which the assist mode is “standard” or stops the generation of the assist power to suppress the power consumption. In the case in which the assist mode is “assist-free mode”, the electric motor 53 does not generate any assist power.

As described above, the assist power in response to the crank rotation output is varied in accordance with the assist mode described above. In this example, the assist mode is switched to any one of four stages. Alternatively, the assist mode may be switched to any of three stages or less, or any of five stages or more.

Now, an operation of changing the magnitude of the assist power to be generated by the electric motor 53 in accordance with the acceleration, which changes in association with the operation of the rider rotating the pedal 55, will be described.

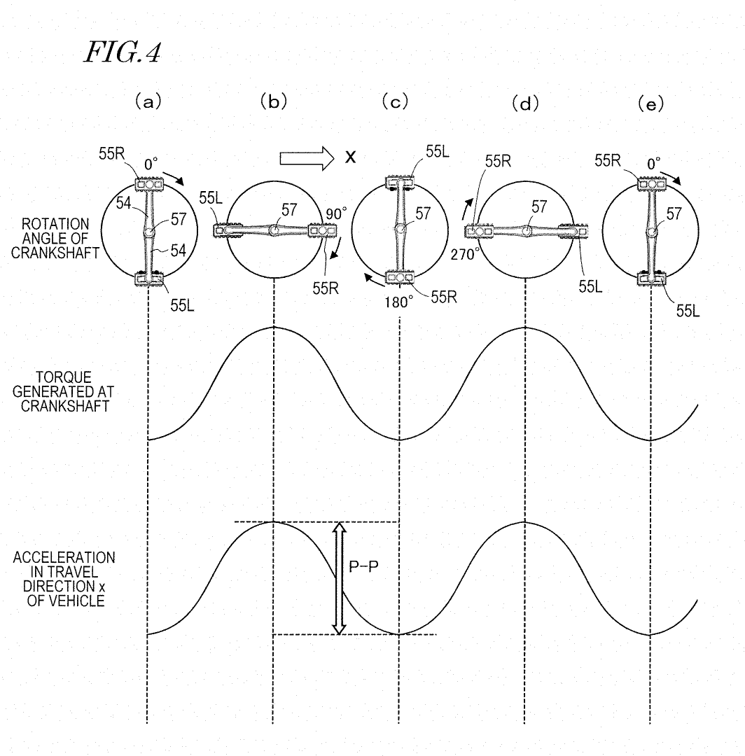

First, the relationship between the operation of the rider rotating the pedal 55 and the acceleration will be described. FIG. 4 shows the relationship among the rotation angle of the crankshaft 57, the torque generated at the crankshaft 57 and the acceleration in the travel direction of the vehicle while the rider is rotating the pedal 55. In the example shown in FIG. 4, the electric assist bicycle 1 is running on a flat road, and the direction from left to right in the figure is assumed to be a travel direction x of the vehicle.

Because of the structure of the electric assist bicycle 1 that allows the rider to have his/her foot step on, and rotate, the pedal 55, the magnitude of the human power (pedal force) of the rider applied to the pedal 55 is increased or decreased in accordance with the position of the pedal 55, namely, the rotation angle of the crankshaft 57. The increase or the decrease in the pedal force applied to the pedal 55 appears as an increase or decrease in the torque generated at the crankshaft 57. When the torque is increased or decreased, the motive power that runs the electric assist bicycle 1 is increased or decreased. Therefore, the acceleration in the travel direction x of the electric assist bicycle 1 is increased or decreased in accordance with the increase or the decrease in the torque.

(a) of FIG. 4 shows a state where a right pedal 55R of the electric assist bicycle 1, on which the rider puts his/her right foot, is located just above the crankshaft 57, whereas a left pedal 55L of the electric assist bicycle 1, on which the rider puts his/her left foot, is located just below the crankshaft 57. The rotation angle of the crankshaft 57 at this point is set as 0 degrees. In this state, the torque generated at the crankshaft 57 by the human power is minimum. In association with the torque, the acceleration in the travel direction x is also minimum.

From the state shown in (a) of FIG. 4, the rider steps on the right pedal 55R, and as a result, the rotation angle of the crankshaft 57 is increased. As the rotation angle of the crankshaft 57 is increased, the torque generated at the crankshaft 57 by the human power is gradually increased. As the torque is gradually increased, the acceleration in the travel direction x of the vehicle is also increased.

(b) of FIG. 4 shows a state where the right pedal 55R is located to the front, in a horizontal direction, of the crankshaft 57, whereas the left pedal 55L is located to the rear, in the horizontal direction, of the crankshaft 57. The rotation angle of the crankshaft 57 at this point is set as 90 degrees. When the rotation angle is 90 degrees, the torque generated at the crankshaft 57 by the human power is maximum. In association with the torque, the acceleration in the travel direction x of the vehicle is also maximum.

From the state shown in (b) of FIG. 4, the rotation angle of the crankshaft 57 is further increased. As the rotation angle of the crankshaft 57 is increased, the torque generated at the crankshaft 57 by the human power is gradually decreased. As the torque is gradually decreased, the acceleration in the travel direction x of the vehicle is also decreased.

(c) of FIG. 4 shows a state where the right pedal 55R is located just below the crankshaft 57, whereas the left pedal 55L is located just above the crankshaft 57. The rotation angle of the crankshaft 57 at this point is set as 180 degrees. When the rotation angle is 180 degrees, the torque generated at the crankshaft 57 by the human power is minimum. In association with the torque, the acceleration in the travel direction x of the vehicle is also minimum.

From the state shown in (c) of FIG. 4, the rider steps on the left pedal 55L, and as a result, the rotation angle of the crankshaft 57 is further increased. As the rotation angle of the crankshaft 57 is increased, the torque generated at the crankshaft 57 by the human power is gradually increased. As the torque is gradually increased, the acceleration in the travel direction x of the vehicle is also increased.

(d) of FIG. 4 shows a state where the left pedal 55L is located to the front, in the horizontal direction, of the crankshaft 57, whereas the right pedal 55R is located to the rear, in the horizontal direction, of the crankshaft 57. The rotation angle of the crankshaft 57 at this point is set as 270 degrees. When the rotation angle is 270 degrees, the torque generated at the crankshaft 57 by the human power is maximum. In association with the torque, the acceleration in the travel direction x of the vehicle is also maximum.

From the state shown in (d) of FIG. 4, the rotation angle of the crankshaft 57 is further increased. As the rotation angle of the crankshaft 57 is increased, the torque generated at the crankshaft 57 by the human power is gradually decreased. As the torque is gradually decreased, the acceleration in the travel direction x of the vehicle is also decreased.

(e) of FIG. 4 shows a state where the right pedal 55R is located just above the crankshaft 57, whereas the left pedal 55L is located just below the crankshaft 57. Namely, (e) of FIG. 4 shows a state where the crankshaft 57 has made one rotation from the state shown in (a) of FIG. 4. The rotation angle of the crankshaft 57 at this point is set as 0 degrees. When the rotation angle is 0 degrees, the torque generated at the crankshaft 57 by the human power is maximum. In association with the torque, the acceleration in the travel direction x of the vehicle is also maximum.

In this manner, the torque generated at the crankshaft 57 increases or decreases in accordance with the rotation angle of the crankshaft 57. As the torque that increases and decreases, a ridge and a trough appear alternately. In synchronization with the increase and the decrease in the torque, the acceleration in the travel direction x of the vehicle increases and decreases. In synchronization with the timings when the ridge and the trough of the torque appear, a ridge and a trough appear alternately in the acceleration that increases and decreases.

In a zone between an adjacent ridge and trough of the torque, a peak of the ridge represents the maximum value of the torque in the zone. A bottom of the trough of the torque represents the minimum value of the torque in the zone. In this specification, the zone between the adjacent ridge and trough includes the peak of the ridge and the bottom of the trough.

In a zone between the adjacent ridge and trough of the acceleration, a peak of the ridge represents the maximum value of the acceleration in the zone. A bottom of the trough of the acceleration represents the minimum value of the acceleration in the zone. In synchronization with the timings at which the adjacent ridge and trough of the torque that increases and decreases appear, the maximum value and the minimum value of the acceleration appear.

The rider riding the electric assist bicycle 1 adjusts the pedal force to be applied to the pedal 55 and the speed at which the pedal 55 is to be rotated, so as to accelerate the electric assist bicycle 1 with the sense of acceleration desired by the rider and thus to run the electric assist bicycle 1 at the speed desired by the rider. In this specification, the manner of the rider pedaling the electric assist bicycle 1 with a torque changing periodically as shown in FIG. 4 will be referred to as a “certain pedaling manner”.

While the rider is pedaling the electric assist bicycle 1 on a flat road in the certain pedaling manner, the rider is considered to wish to run the electric assist bicycle 1 at an acceleration changing periodically as shown in FIG. 4. Meanwhile, the electric assist bicycle 1 is influenced by various external disturbances. For this reason, the acceleration changing periodically as shown in FIG. 4 may not be obtained. For example, a headwind caused by the running of the electric assist bicycle 1, a wind meteorologically generated and/or a slope are all examples of the external disturbances.

The present inventor conceived adjusting the assist power of the electric assist bicycle 1 such that while the rider is pedaling the electric assist bicycle 1 in the certain pedaling manner, the rider runs the electric assist bicycle 1 with the sense of acceleration changing periodically as shown in FIG. 4 regardless of whether there is any external disturbance or not. The “sense of acceleration” used in this specification refers to the sense of speed that the rider feels by increase or decrease in the speed in the travel direction while running the electric assist bicycle 1 with the acceleration changing periodically as shown in FIG. 4. The “sense of acceleration” is different from the acceleration detected by the acceleration sensor 38. As described below, on a slope, the acceleration sensor 38 detects an acceleration in accordance with the inclination. Therefore, even when the electric assist bicycle 1 is at a stop, the acceleration sensor 38 outputs a certain value that is not zero. For this reason, even if the electric assist bicycle 1 runs with exactly the same change in the speed on a flat road and on a slope, the acceleration detected by the acceleration sensor 38 on the flat road, and the acceleration detected by acceleration sensor 38 on the slope, do not match each other. However, if the assist power is adjusted appropriately, the rider running with an influence of an external disturbance, for example, the rider running on a slope, may pedal the electric assist bicycle 1 with the same sense of acceleration as that on the flat road. The “same sense of acceleration” may be rephrased as, for example, the same average speed per hour in a certain time period. In a preferred embodiment of the present invention, the rider is allowed to drive the electric assist bicycle 1 with the same sense of acceleration while running on a flat road and while running with a load.

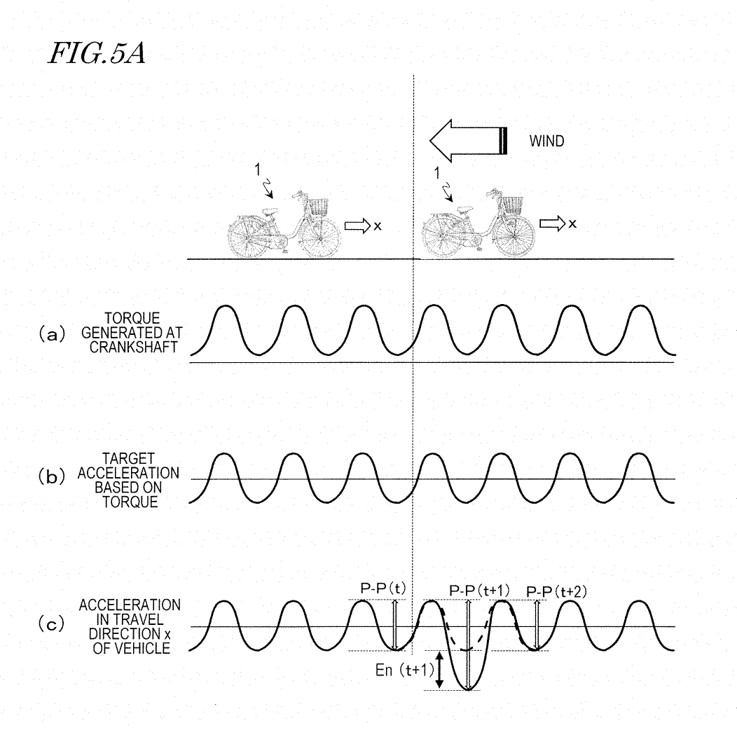

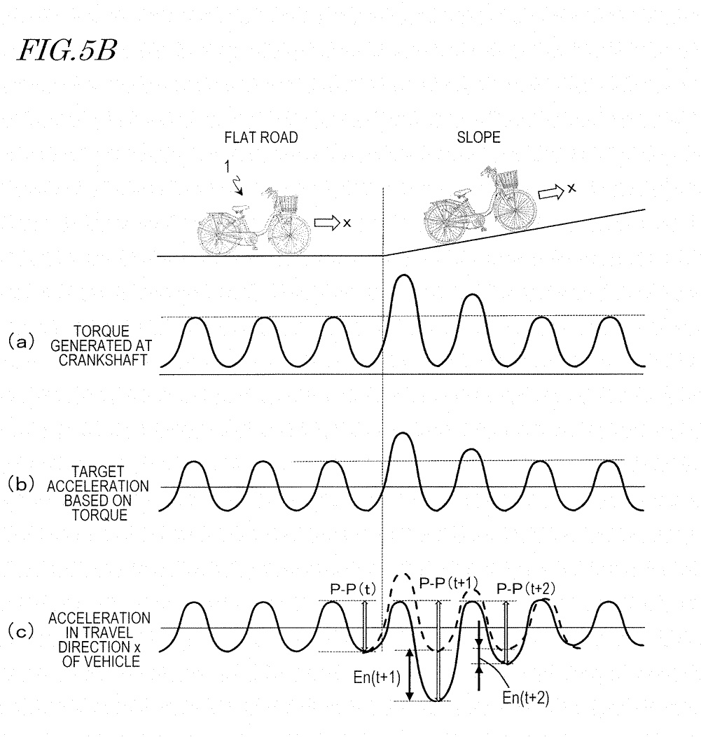

Hereinafter, an overview of an operation of the electric assist bicycle 1 according to this preferred embodiment will be described with reference to FIGS. 5A and 5B.

FIG. 5A shows an example of the motion of the electric assist bicycle 1 in the case in which the rider is subjected to a headwind as a load. It is assumed that there is no wind up to a certain time point, and then the rider is subjected to the headwind at the timing represented by the dotted line parallel to the up-down direction of the figure.

(a) of FIG. 5A schematically shows a waveform of a value of the torque obtained based on the torque signal. As understood from the waveform in (a) of FIG. 5A, the rider rides the electric assist bicycle 1 in the certain pedaling manner. In this preferred embodiment, the controller 70 calculates a target acceleration from the torque signal, and determines the magnitude of the assist power to be generated by the electric motor 53 such that the deviation between the target acceleration and the current acceleration is decreased.

The present inventor considered that the value of the torque represented by the torque signal is a value directly indicating what acceleration the rider wishes to drive the electric assist bicycle 1, and set a map or a function defining the correspondence between the torque signal and the target acceleration. The map or function may be used to determine the target acceleration uniquely from the value of the torque.

(b) of FIG. 5A schematically shows a waveform of the target acceleration calculated based on the torque. In general, as the value of the torque is smaller, the target acceleration is smaller; whereas as the value of the torque is larger, the target acceleration is larger. The value of the target acceleration may be increased or decreased in synchronization with the value of the torque.

(c) of FIG. 5A schematically shows the acceleration in the travel direction x of the vehicle. The solid line represents a waveform of the acceleration signal that is output from the acceleration sensor 38, and the dashed line represents the waveform of the target acceleration. Hereinafter, a difference between the adjacent ridge and trough of the acceleration at time t will be referred to as “P−P(t)”, for example.

The difference P−P(t) and a difference P−P(t+1) will be compared against each other. The acceleration value of the latter has a larger amplitude in the negative direction. Therefore, the deviation En(t+1) between the acceleration value and the target acceleration value at time (t+1) is relatively large.

In this preferred embodiment, the controller 70 determines the magnitude of the assist power to be generated by the electric motor 53 such that the deviation En(t+1) is decreased. The term “decreased” refers to, for example, “made 0 (zero)”.

After the electric assist bicycle 1 is subjected to the headwind, the controller 70 generates a larger assist power. As a result, at time (t+2), a deviation En(t+2) is converged to approximately 0. This indicates that the rider is subjected to the headwind but maintains the same acceleration as long as the rider keeps on pedaling the electric assist bicycle 1 with the same pedal force (torque).

FIG. 5B shows an example of the motion of the electric assist bicycle 1 in the case in which the rider receives, from a slope, a downward force parallel to the inclining surface as a load. It is assumed that the electric assist bicycle 1 runs on a flat road up to a certain time point and then, starts running on a slope at the timing represented by the dotted line parallel to the up-down direction of the figure. (b) and (c) of FIG. 5B respectively show the target acceleration and the current acceleration. In each of (b) and (c) of FIG. 5B, the waveform after the electric assist bicycle 1 starts running on the slope is provided as a waveform obtained as a result of removing, by a high-pass filter, a low-frequency component of the acceleration which is added in accordance with the slope. This process will be described below in detail.

(a) of FIG. 5B schematically shows a waveform of a value of the torque obtained based on the torque signal. As understood from the waveform in (a) of FIG. 5B, the rider rides the electric assist bicycle 1 in the certain pedaling manner on a flat road, but pedals the electric assist bicycle 1 with a larger pedal force immediately after the start of the slope. Such a manner of pedaling is common. A reason for this is that before and after the start of the slope, the rider expects that the speed will be decreased due to the ascending slope, and intuitively pedals the electric assist bicycle 1 strongly.

(b) of FIG. 5B schematically shows a waveform of the target acceleration calculated based on the torque. As described above regarding (b) of FIG. 5A, as the value of the torque is smaller, the target acceleration is smaller; whereas as the value of the torque is larger, the target acceleration is larger. It is understood that in synchronization with the larger pedal force immediately after the start of the slope, the target acceleration is calculated to be larger than that before the start of the slope.

(c) of FIG. 5B schematically shows the acceleration in the travel direction x of the vehicle. The solid line represents a waveform of the acceleration signal that is output from the acceleration sensor 38, and the dashed line represents the waveform of the target acceleration.

The difference P−P(t) and the difference P−P(t+1) will be compared against each other. The acceleration value of the latter has a larger amplitude in the negative direction. Therefore, the deviation En(t+1) between the acceleration value and the target acceleration value at time (t+1) is relatively large.

The controller 70 determines the magnitude of the assist power to be generated by the electric motor 53 such that the deviation En(t+1) is decreased. In this example also, the term “decreased” refers to, for example, “made 0 (zero)”.

After the electric assist bicycle 1 starts running on the slope, the controller 70 generates a larger assist power. As a result, the difference P−P(t+2) is smaller than the difference P−P(t+1). However, the difference P−P(t+2) is not converged to 0. Therefore, the controller 70 further determines the magnitude of the assist power to be generated by the electric motor 53 such that the deviation En(t+2) between the acceleration value and the target acceleration value at time (t+2) is decreased. As a result of such a process, the deviation regarding the electric assist bicycle 1 after time (t+2) is converted to approximately 0.

As the electric assist bicycle 1 advances on the slope, the electric motor 53 generates a larger assist power. Therefore, the rider gradually decreases the pedal force (torque) and as a result, returns the pedal force to the level on the flat road. After starting running on the slope, the rider may return the pedal force (torque) to the same level of pedal force as that on the flat road within a sufficiently short time period, and may still obtain the same sense of acceleration as that on the flat road.

With the above-described control, the rider does not need to pedal the electric assist bicycle 1 strongly when the load is heavy, and the electric assist bicycle 1 is prevented from jumping out due to excessively large assist power when the load is light. Namely, the rider may obtain a desired sense of acceleration, which is substantially the same as that on the flat road, regardless of whether the load is heavy or light as long as the rider keeps on riding the electric assist bicycle 1 in the certain pedaling manner.

Now, an internal structure of the controller 70 will be described with reference to FIG. 2A again, and then, an operation performed by the controller 70 will be described.

As described above, the controller 70 includes the calculation circuit 71, the averaging circuit 78, and the motor driving circuit 79. The calculation circuit 71 will be described as being an integrated circuit including a plurality of circuits in this preferred embodiment, but such a structure is an example. A process realized by one or a plurality of circuits may be realized by a software and a signal processor.

The averaging circuit 78 is a digital filtering circuit that smoothes a detection signal regarding each of the axial directions that is output from the acceleration sensor 38. The averaging circuit 78 may, for example, calculate a moving average of a plurality of detection signals to smooth the detection signals. Another smoothing algorithm may be used. In this preferred embodiment, the averaging circuit 78 is provided. Nonetheless, according to a preferred embodiment of the present invention, it is not indispensable to provide the averaging circuit 78.

The calculation circuit 71 performs a calculation of determining a motor electric current command value from the assist mode or the like, performs a calculation of determining a target acceleration based on the torque, performs a calculation of determining a motor torque at which the deviation between the target acceleration and the current acceleration is decreased and correcting the motor electric current command value such that the obtained motor torque is generated, performs a calculation of further correcting the corrected motor command value in consideration of a condition such as the speed or the like, and outputs a control signal.

In this preferred embodiment, the calculation circuit 71 includes functional blocks that perform a plurality of types of processes. Specifically, the calculation circuit 71 includes a target acceleration calculation block 72, a high-pass filter 73, a motor electric current command value calculation block 74, motor electric current command value correction blocks 75 and 76, and a storage block 77. Each of the functional blocks other than the storage block 77 may be mounted as a calculation core in the calculation circuit 71, or may be mounted as a sub routine or a library of a computer program.

The target acceleration calculation block 72 receives a torque signal from the torque sensor 41, and refers to an acceleration calculation rule 77a stored in advance in the storage block 77 described below to calculate the target acceleration from the torque signal.

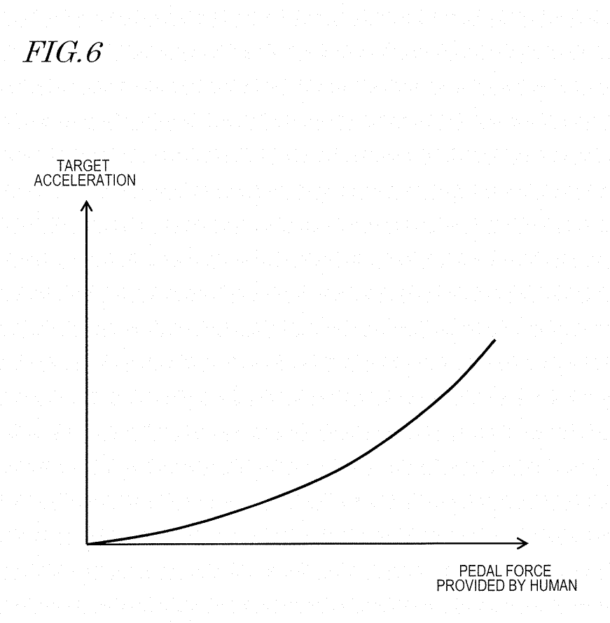

FIG. 6 shows an example of the acceleration calculation rule 77a representing the relationship between the pedal force provided by the human (torque signal) and the target acceleration. As described above, the present inventor considered that once the pedal force of the rider is determined, the acceleration desired by the rider is specified uniquely. Thus, the present inventor prepared, in advance, the correspondence between the pedal force provided by the human (torque signal) and the target acceleration in the form of the acceleration calculation rule 77a, and stored the acceleration calculation rule 77a in the storage block 77. The target acceleration calculation block 72 refers to the acceleration calculation rule 77a to calculate the target acceleration based on the pedal force obtained from the torque sensor 41.

In FIG. 6, the correspondence between torque signal and the target acceleration is represented as a nonlinear continuous function. This is an example. The correspondence between torque signal and the target acceleration may be represented as a linear continuous function, or may be represented by a map or a table that associates the signal value of the torque signal and the target acceleration in a one-to-one manner.

The example shown in FIG. 6 may be extended. In the case in which any assist mode is selectable, a different function, map or table may be selected in accordance with the selected assist mode.

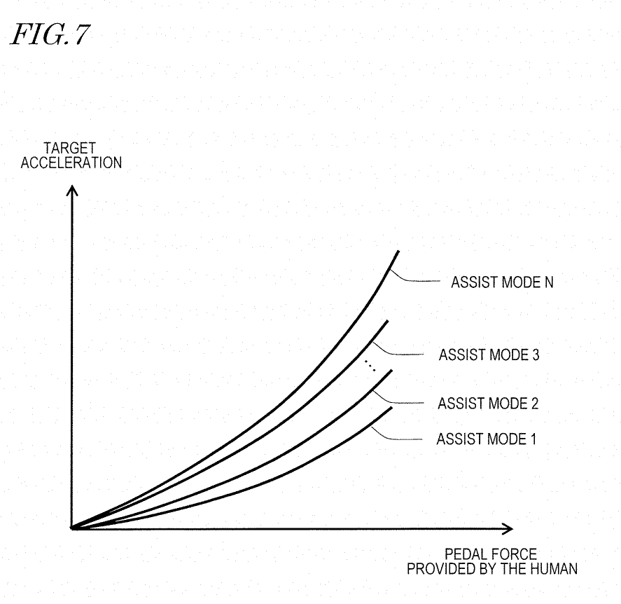

FIG. 7 shows the relationship between the pedal force provided by the human (torque signal) and the target acceleration that is defined for each of the N pieces of selectable assist modes. It is assumed that the assist ratio is lowest in assist mode 1 and is highest in assist mode N. In the example shown in FIG. 7, as the assist mode is of a higher assist ratio, a larger target acceleration may be set for the same pedal force.

Specific profiles in FIG. 6 and FIG. 7 may be appropriately determined by a designer or a producer of the electric assist bicycle 1 based on the specifications or the like of the electric assist bicycle 1. In other words, unless the specifications of the electric assist bicycle 1 are determined, the specific profiles in FIG. 6 and FIG. 7 are not determined. A reason for this is that even with the same pedal force, the acceleration performance significantly varies in accordance with, for example, the diameter, the number of teeth or the like of each of the sprocket (not shown) attached to the crankshaft and the sprocket (not shown) attached to the rear wheel.

The motor electric current command value calculation block 74 calculates the motor electric current command value, based on which subsequent processes are to be performed. In general, the magnitude of the torque to be generated by the electric motor 53 is in proportion to the level of the electric current to flow in the electric motor 53. Once the level of the electric current that is to flow in the electric motor 53 is determined, the magnitude of the torque to be generated is determined uniquely. Namely, determining the motor electric current command value is determining the magnitude of the torque to be generated by the electric motor 53.

First, a method for calculating the motor electric current command value will be generally described, and then will be described in detail. The motor electric current command value calculation block 74 receives data specifying the assist mode selected by the rider by use of the operation panel 60, and sets the assist mode. A reason for this is that the map or rule to be used to determine the motor electric current command value is different in accordance with the assist mode. The motor electric current command value calculation block 74 also receives a value representing the magnitude of the pedal torque detected by the torque sensor 41. The magnitude of the pedal torque is one of parameters usable to determine the assist power. The motor electric current command value calculation block 74 further receives, from a transmission gear range sensor 48, data representing the transmission gear range of the transmission. The transmission gear range sensor 48 detects the transmission gear range of the transmission included in the power transmission mechanism 31. The magnitude of the assist power to be applied to the ground by the rear wheel 26 changes in accordance with the level of the transmission gear range. Therefore, the output value of the transmission gear range sensor 48 is also considered to be one of the basic parameters usable to calculate the motor electric current command value. The motor electric current command value calculation block 74 further receives speed data from the speed sensor 35.

The motor electric current command value calculation block 74 determines the motor electric current command value such that the ratio between the torque to be generated at a driving shaft of the rear wheel 26 by the pedal force and the torque to be generated at the driving shaft of the rear wheel 26 by the driving motor 53 matches the assist ratio. The “assist ratio” is a ratio of the assist output generated by the electric motor 53 with respect to the crank rotation output that is generated by the human power of the rider applied to the pedal 55. The assist ratio may also be referred to as a “driving assist ratio”.

The motor electric current command value calculation block 74 determines the motor electric current command value such that, for example, the torque to be generated at the driving shaft of the rear wheel 26 by the pedal force and the torque to be generated at the driving shaft of the rear wheel 26 by the driving motor 53 are equal to each other (assist ratio is 1:1). The motor electric current command value may be determined by use of, for example, a predefined “table representing the relationship between the human power torque and the motor electric current command value”. In this process, the motor electric current command value calculation block 74 calculates the motor electric current command value further in consideration of the deceleration ratio of the decelerator that decelerates the rotation of the electric motor 53. When, for example, the deceleration ratio is N, the motor electric current command value calculation block 74 calculates the motor electric current command value such that a motor torque that is 1/N of the torque to be generated at the driving shaft of the rear wheel 26 by the pedal force is generated. When, for example, the deceleration ratio is 2, the motor electric current command value calculation block 74 calculates the motor electric current command value such that a motor torque that is ½ of the torque to be generated at the driving shaft of the rear wheel 26 by the pedal force is generated.

Next, the motor electric current command value calculation block 74 multiplies the motor electric current command value by a coefficient in accordance with the assist mode set by the user. For example, the coefficient is set to 2 when the assist mode is “high”, the coefficient is set to 1 when the assist mode is “standard”, and the coefficient is set to 0.8 when the assist mode is “low”. With such settings, the motor electric current command value calculation block 74 multiplies the motor electric current command value by the coefficient corresponding to the assist mode set by the user.

Next, the motor electric current command value calculation block 74 corrects the motor electric current command value in consideration of the vehicle speed. In the case in which, for example, the vehicle speed is low, the motor electric current command value calculation block 74 sets the motor electric current command value to be relatively large. As the vehicle speed is increased, the motor electric current command value calculation block 74 decreases the motor electric current command value. The motor electric current command value calculation block 74 sets the motor electric current command value in this manner, so that the assist power at the start of the vehicle is increased and thus the feel of driving is improved.

Next, the motor electric current command value calculation block 74 corrects the motor electric current command value in consideration of the transmission gear range. In the case in which, for example, the current transmission gear range is lower than, or equal to, a predefined transmission gear range, the motor electric current command value calculation block 74 may set the level of the electric current that is to flow in the electric motor 53 to be relatively low. With such a setting, the magnitude of the assist power to be generated by the electric motor 53 is suppressed, and the acceleration of the vehicle is prevented from becoming excessively large. Thus, the feel of driving is improved.

The motor electric current command value calculation block 74 may calculate the transmission gear range from the rotation speed of the electric motor 53 and the running speed of the vehicle main body. The motor electric current command value calculation block 74 calculates the transmission gear range by use of the output signal of the motor rotation sensor 46 and the output signal of the speed sensor 35. In this case, the transmission gear range sensor 48 may be omitted.

The above-described order of the processes performed by the motor electric current command value calculation block 74 is merely an example. The processes may be performed in an order different from the above. For example, the motor electric current command value calculation block 74 may first correct the motor electric current command value in consideration of the transmission gear range and then correct the motor electric current command value in consideration of the vehicle speed. Provision of the transmission gear range sensor 48 is not indispensable in this preferred embodiment. The motor electric current command value calculation block 74 outputs the motor electric current command value to the motor electric current command value correction block 75.

Now, the high-pass filter 73 will be described. The high-pass filter 73 is a digital filter that transmits a component of a predefined frequency, for example, a high-frequency component of 5 Hz or higher. It should be noted that in the case in which an analog acceleration signal is input to the high-pass filter 73, the high-pass filter 73 is an analog filter. The basis for “5 Hz” mentioned above will be described briefly. Assuming that the cadence is 200 rpm at the maximum, the pedal makes 3.3 rotations per second. Namely, the rotation of the pedal is 3.3 Hz. With a margin of about 1.5 times this value, the value “5 Hz” is determined. The value does not need to be precisely 5 Hz, and may be appropriately adjusted by a person of ordinary skill in the art.

The motor electric current command value correction block 75 receives the motor electric current command value calculated by the motor electric current command value calculation block 74, the value of the target acceleration that is output from the target acceleration calculation block 72, and the value of the acceleration sensor 38 (value of the detected acceleration) that is output from the high-pass filter 73. The motor electric current command value correction block 75 corrects the motor electric current command value such that the detected acceleration matches the target acceleration.

An overview of a method for correction is as follows.

Correction method (a): in the case in which the detected acceleration is smaller than the target acceleration, the motor electric current command value correction block 75 increases the motor electric current command value by correction.

Correction method (b): in the case in which the detected acceleration is maintained at the target acceleration, the motor electric current command value correction block 75 maintains the motor electric current command value.

Correction method (c): in the case in which the detected acceleration is larger than the target acceleration, the motor electric current command value correction block 75 decreases the motor electric current command value by correction.

In this preferred embodiment, PID control is used as one of processes suitable as the above-described correction method. The motor electric current command value correction block 75 uses the PID control to calculate the motor torque to be generated by the electric motor 53. Next, the motor electric current command value correction block 75 determines the motor electric current command value that is required to generate the calculated motor torque, and determines the difference between the determined motor electric current command value and the current motor electric current command value. The difference may be of a positive value, 0, or of a negative value.

The process performed by the motor electric current command value correction block 75 will be described specifically. Now, feedback gains of a proportional element, a differential element and an integration element of the driving unit 51 are respectively represented as Kp, Kd and Ki. The current deviation at the time t is represented as e(t).

The motor electric current command value correction block 75 determines the motor torque Fm, corresponding to the assist power to be generated, by the electric motor 53 by the following expression.

$$Fm ( t ) = Kp \times e ( t ) + Ki \times {\int }_{0}^{t} e ( τ ) d τ + Kd \times \frac{de ( t )}{dt} . \qquad Expression 1$$

The first term of the right side represents a calculation regarding the proportional element (proportion control calculation). In general, the proportion control calculation is used to smoothly make a current value close to a target value. As the deviation is decreased, namely, as the current value is made closer to the target value, the amount of operation based on the proportion control calculation is decreased. The motor electric current command value correction block 75 determines the torque of a magnitude in proportion to the immediately previous deviation.

The second term of the right side represents a calculation regarding the integration element (integration control calculation). In the above-described proportion control calculation, the amount of operation is decreased as the current value is made closer to the target value. Therefore, the deviation remains. The integration control calculation is used to further decrease such a residual deviation. As a result of the integration control calculation, the residual deviation is temporally accumulated. When the residual deviation reaches a certain magnitude, the amount of operation may be increased to further decrease the residual deviation. The motor electric current command value correction block 75 determines the torque of a magnitude in proportion to the accumulated value of the residual deviation.

The third term of the right side represents a calculation regarding the differential element (differential control calculation). In general, the differential control calculation is used to improve the responsiveness (speed of response) when an external disturbance occurs. When the difference between the immediately previous deviation and the current deviation is increased by a sudden external disturbance, the amount of operation is increased in accordance with the difference to improve the ability to follow a change caused by the external disturbance. The motor electric current command value correction block 75 determines the torque of a magnitude in proportion to the differential of the residual deviation.

The feedback gains Kp, Kd and Ki of the proportion element, the differential element and the integration element may vary in accordance with the performance of the electric motor 53, the specifications of the power transmission mechanism of the electric assist bicycle 1, or the like. In a model at the time of designing the control system, the specifications of the electric assist bicycle 1 are deeply related with, for example, how the waste time until the rise of control response, the time constant, and the steady-state value to be converged are to be set. This is also applicable to how the feedback gains Kp, Kd and Ki are to be set.

Upon calculating the motor torque Fm by expression 1 shown above, the motor electric current command value correction block 75 determines the motor electric current command value required to generate the motor torque Fm. The relationship between the motor torque Fm and the electric current command value is available in advance as an index that represents the performance of the electric motor 53. The motor electric current command value correction block 75 holds, in advance, a motor torque-electric current command value correspondence table, which represents the relationship. The motor electric current command value correction block 75 refers to the table to determine the electric current command value required to generate the motor torque Fm obtained by expression 1. Then, the motor electric current command value correction block 75 corrects the electric current command value such that the current electric current command value becomes such a newly determined electric current command value.

The left side of expression 1 shown above represents the motor torque Fm. Alternatively, the electric current command value may be directly determined. In this case, the feedback gains Kp, Kd and Ki in the right side of expression 1 may be changed to values obtained in consideration of the contents of the motor torque-electric current command value correspondence table mentioned above. Feedback gains to be used to determine the electric current command value from the proportion term, the integration term and the differential term regarding the residual deviation will be respectively represented as Kp′, Kd′ and Ki′. The motor electric current command value correction block 75 may determine an electric current command value Im(t), to be generated by the electric motor 53, by the following expression 2.

$$Im ( t ) = {Kp}^{′} \times e ( t ) + {Ki}^{′} \times {\int }_{0}^{t} e ( τ ) d τ + {Kd}^{′} \times \frac{de ( t )}{dt} . \qquad Expression 2$$

Whether the electric current command value is to be determined from the motor torque Fm by use of the motor torque-electric current command value correspondence table or is to be determined directly from expression 1 by changing the feedback gains is an issue of designing. Either method may be used.

The motor electric current command value correction block 75 outputs the motor electric current command value to the motor electric current command value correction block 76.

Now, the motor electric current command value correction block 76 will be described. The motor electric current command value correction block 76 further corrects the motor electric current command value corrected by the motor electric current command value correction block 75. The purpose of the correction is to gradually decrease the motor torque in accordance with the vehicle speed and to improve the feel of riding in consideration of the crank rotation. Hereinafter, this will be described specifically.

The motor electric current command value correction block 76 corrects the motor electric current command value in accordance with the vehicle speed. In Japan, there is a regulation that when the vehicle speed is of a predetermined value or higher (e.g., 10 km per hour or higher), the upper limit of the assist ratio should be decreased. When the vehicle speed is 10 km per hour or higher, the upper limit of the assist ratio is gradually decreased. When the vehicle speed is 24 km per hour or higher, the assist ratio is 1:0, namely, the assist output is zero. The motor electric current command value correction block 76 determines the ratio of such gradual decrease by use of, for example, a predefined “table representing the relationship between the vehicle speed and the ratio of gradual decrease”. The motor electric current command value is multiplied by the ratio of gradual decrease, so that the torque to be generated by the electric motor 53 is gradually decreased. The change in the ratio of gradual decrease may be linear or curved.

The motor electric current command value correction block 76 also corrects the motor electric current command value in accordance with the rotation speed of the crankshaft 57. While, for example, the electric assist bicycle 1 is running at a low speed immediately before stopping, the feel of driving varies in accordance with when the generation of the assist power is stopped. For example, there is a case in which the feel of driving is improved by generating a slight assist power continuously even though the pedal force is substantially zero. In such a case, the rotation speed of the crankshaft 57 may be referred to, so that it is checked whether or not the rider intends to drive. While the crankshaft 57 is moving, namely, the rider is pedaling, the assist power is generated; and when the crankshaft 57 is stopped, the generation of the assist power is stopped. In this manner, the feel of driving is improved.

The motor electric current command value correction block 76 outputs the motor electric current command value to the motor driving circuit 79. The motor driving circuit 79 supplies the electric motor 53 with an electric current of a level in accordance with the motor electric current command value.

The process performed by the motor driving circuit 79 will be described specifically.

The motor electric current command value received by the motor driving circuit 79 represents the level of the electric current to be actually caused to flow in the electric motor 53. The motor electric current command value is considered to represent the target motor electric current value. The motor driving circuit 79 monitors and controls the amount of the electric current such that the electric current of the level indicated by the target motor electric current value flows. It is preferred that the control performed in this process is feedback control. In this preferred embodiment, the motor driving circuit 79 performs PID control as the feedback control. The PID control is a well-known control method represented by expression 1 shown above. Thus, the details of the process will not be described. The motor driving circuit 79 may use any control method as long as the level of the electric current actually flowing may be controlled to match the motor electric current command value.

The driving unit 51 includes an electric current sensor 47 in order to monitor the electric current. The electric current sensor 47 detects a value of the electric current flowing in the electric motor 53 and outputs the value to the motor driving circuit 79. The motor driving circuit 79 uses the output signal of the electric current sensor 47 to perform the feedback control.

The electric motor 53 shown in FIG. 2A is a three-phase motor including three-phase (U phase, V phase and W phase) coils. The electric motor 53 is, for example, a brushless DC motor.

In the example shown in FIG. 2A, the electric current sensor 47 detects the electric current flowing in each of the coils of the three phases (U phase, V phase and W phase). The electric current sensor 47 may detect the electric current flowing in each of the coils of only two phases, instead of the electric current flowing in each of the coils of the three phases, for the following reason. In the three-phase energization control, a sum of values of the electric currents flowing in the coils of the three phases is theoretically zero; and this relationship may be used to determine the value of the electric current flowing in the coil of the remaining phase, from the values of the electric currents flowing in the coils of the two phases. In this manner, the value of the electric current flowing in each of the coils of the three phases may be acquired. In the U, V and W coils, the electric currents of sine waveforms that are shifted by 120 degrees with respect to each other flow. The “value of the electric current” generally refers to the amplitude of the waveform, and may be represented as the difference P-P (Peak to Peak) between the maximum value and the minimum value of the electric current. A method for calculating the difference P-P from an actual measurement value of the electric current is well-known. The motor driving circuit 79 may substitute two actual measurement values of the electric currents, detected by the electric current sensor 47, into a predetermined calculation expression to determine the difference P-P.

The storage block 77 is a storage provided in the calculation circuit 71. An example of the storage block 77 is a ROM or a flash memory, which is a nonvolatile memory, a RAM, which is a volatile memory, a buffer, or a register. The storage block 77 stores the data on the acceleration calculation rule 77a described above.

With the above-described process, the calculation circuit 71 may rotate the electric motor 58 at such an assist ratio that decreases the deviation in the acceleration.

Now, the process performed by the controller 70 in the driving unit 51 will be described in detail.

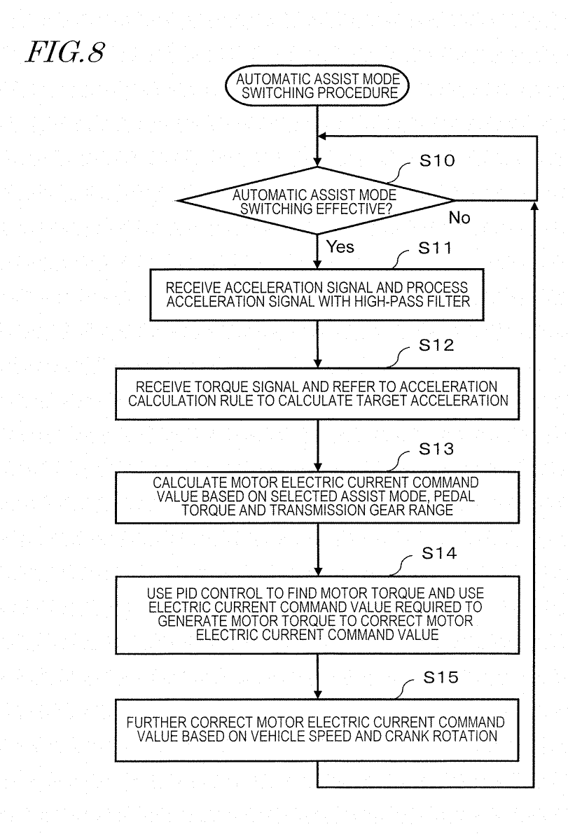

FIG. 8 is a flowchart showing a procedure performed by the controller 70.

In step S10, the controller 70 determines whether or not the automatic assist mode switching is effective. Only when the automatic assist mode switching is effective, the controller 70 advances the procedure to the next step, i.e., step S11. The process performed in the case in which the determination result is “No” in step S10 is set with an assumption that the rider fixes the assist mode. In such a case, it is not necessary to operate the electric assist bicycle 1 against the intention of the rider. A mode in which the automatic assist mode switching is effective, and a mode in which automatic assist mode switching is ineffective, may be switched to each other by a hardware button or a software process. In the latter case, it may be determined whether or not the electric assist bicycle 1 is in a lock mode, in which the assist mode switching is prohibited by pressing and holding down the power source button 65. Instead of, or in addition to, determining whether or not the automatic assist mode switching is effective, the controller 70 may be set such that a mode in which the assist power is permitted to be adjusted in accordance with the deviation in the acceleration described below, and a mode in which the assist power is not permitted to be adjusted, are switchable to each other. Such modes may also be switched to each other by a hardware button or a software process.

In step S11, the averaging circuit 78 receives an acceleration signal from the acceleration sensor 38. The averaging circuit 78 smooths the acceleration signal and outputs the resultant signal to the high-pass filter 73. The high-pass filter 73 transmits a high-frequency component of a predefined frequency or higher from the smoothed acceleration signal to remove a frequency component of a frequency lower than the predefined frequency. In the case in which the averaging circuit 78 is not provided, the acceleration signal that is output from the acceleration sensor 38 may be input to the high-pass filter 73 with no process being made on the acceleration signal.

In step S12, the target acceleration calculation block 72 receives a torque signal that is output from the torque sensor 41, and refers to the acceleration calculation rule 77a stored on the storage block 77 to calculate the target acceleration from the value of the torque signal. In the case in which the acceleration calculation rule 77a includes, for example, a plurality of functions that may change in accordance with the assist mode as shown in FIG. 7, the target acceleration calculation block 72 receives information representing the currently selected assist mode from the operation panel 60.

In step S13, the motor electric current command value calculation block 74 calculates the motor electric current command value based on the selected assist mode, the pedal torque and the transmission gear range.

In step S14, the motor electric current command value correction block 75 uses expression 1 shown above to calculate the motor torque Fm(t). The motor electric current command value correction block 75 also refers to the motor torque-electric current command value correspondence table prepared in advance to determine the electric current command value required to generate the motor torque. The motor electric current command value correction block 75 uses the obtained electric current command value to correct the motor electric current command value.

In step S15, the motor electric current command value correction block 76 further corrects the electric current command value, corrected by the motor electric current command value correction block 75, based on the vehicle speed and the crank rotation.

The electric current command value further corrected by the motor electric current command value correction block 76 is transmitted to the motor driving circuit 79, and the motor driving circuit 79 causes an electric current to flow in the electric motor 53. As a result, the rotation motor 53 is rotated to generate the motor torque Fm(t) determined above.

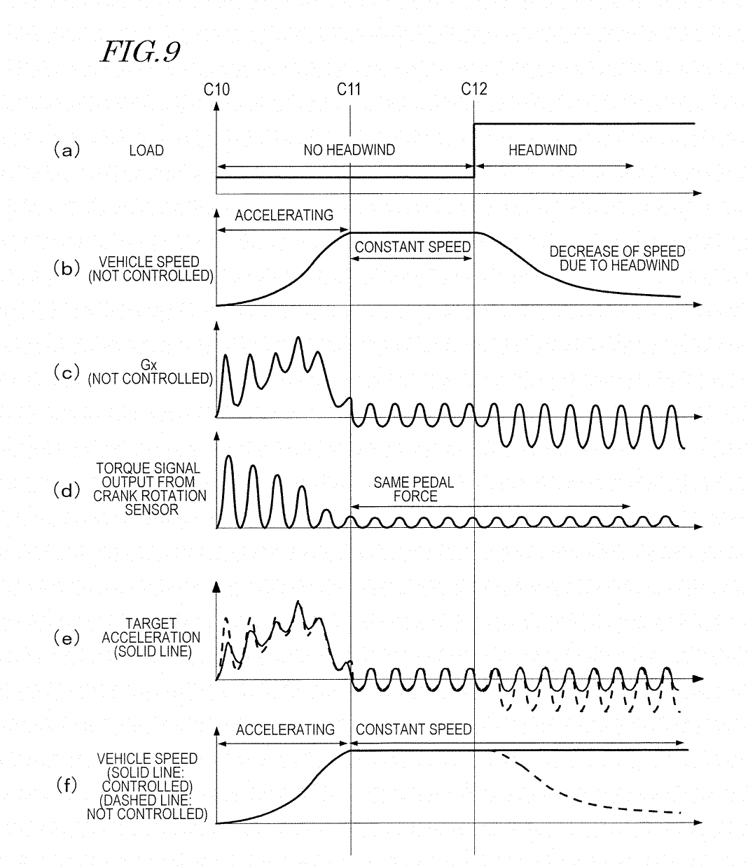

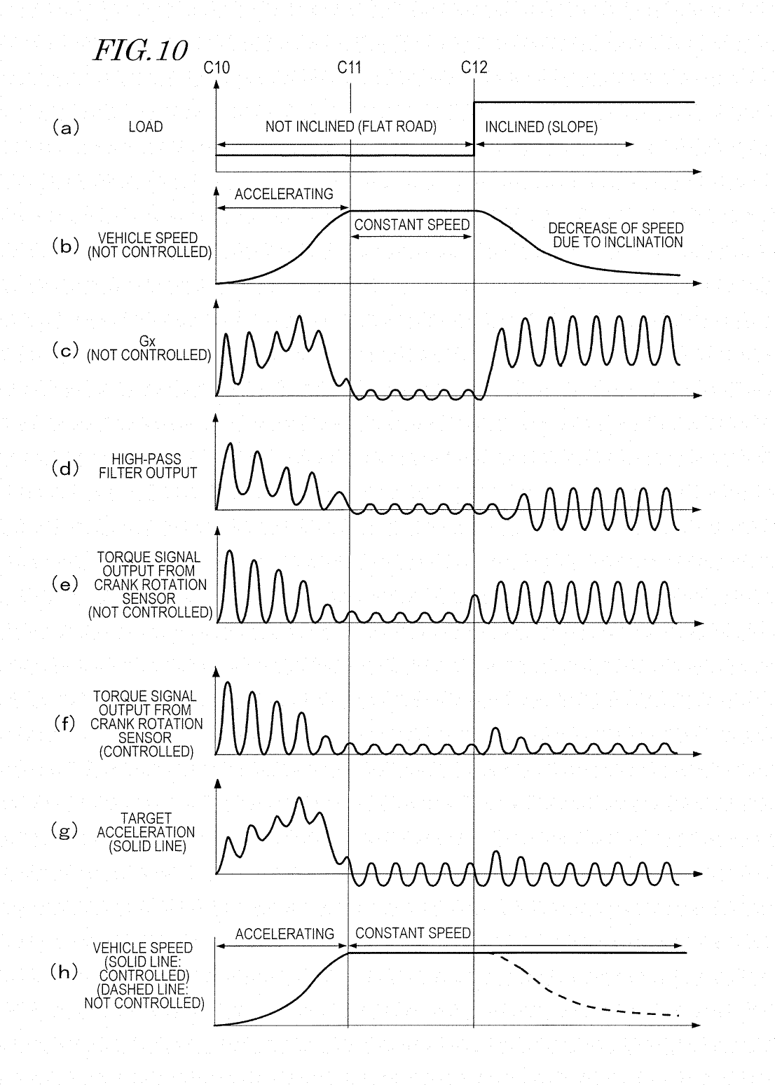

Now, with reference to FIG. 9 and FIG. 10, waveforms of various signals during the above-described process will be described specifically. In each of FIG. 9 and FIG. 10, the horizontal axis represents the time. The time passes in a direction from left to right in the figures.

FIG. 9 shows waveforms of various signals when a load change occurs while the rider is pedaling the electric assist bicycle 1 in the certain pedaling manner. The load change is assumed to be caused by a headwind occurring while the electric assist bicycle 1 is running on a flat road. The situation shown in FIG. 9 corresponds to FIG. 5A referred to above.

In FIG. 9(a), the vertical axis represents the magnitude of the load received by the electric assist bicycle 1 and the rider thereof. In FIG. 9(b), the vertical axis represents the vehicle speed in the travel direction of the vehicle. In state C12 and thereafter, FIG. 9(b) shows the vehicle speed in the case in which the process according to this preferred embodiment is not performed. In FIG. 9(c), the vertical axis represents the acceleration signal Gx in the x-axis direction that is output from the acceleration sensor 38. In state C12 and thereafter, FIG. 9(c) shows a waveform of the vehicle acceleration signal Gx in the x-axis direction in the case in which the control according to this preferred embodiment is not performed.

In FIG. 9(d), the vertical axis represents the torque signal that is output from the crank rotation sensor 42. In FIG. 9(e), the vertical axis represents the target acceleration (solid line), in the travel direction of the vehicle, determined from the torque signal. In FIG. 9(f), the vertical axis represents the vehicle speed (solid line) in the travel direction of the vehicle in the case in which the control according to this preferred embodiment is performed. For reference, FIG. 9(e) and FIG. 9(f) also show, with the dashed lines, the waveform of the actual acceleration signal Gx in the x-axis direction and the waveform of the vehicle speed, respectively, in the case in which the control according to this preferred embodiment is not performed.

In state C10, the electric assist bicycle 1 is at a stop on a flat road. From this state, the rider steps on the pedal 55 to start the electric assist bicycle 1. At the time of starting, the rider strongly steps on the pedal 55, and therefore, the torque generated at the crankshaft 57 is large (FIG. 9(d)) and the vehicle acceleration is also large (FIG. 9(c)). Then, as the speed increases, the rider decreases the pedal force, and the peak of the torque generated at the crankshaft 57 is gradually decreased (FIG. 9(d)). In step C11 and thereafter, the rider determines that the electric assist bicycle 1 has reached the speed desired by him/her, and starts rotating the pedal 55 in the certain pedaling manner. As a result, in state C11 and thereafter, the torque signal changes periodically (FIG. 9(d)).

As shown in FIG. 9(e), in this example, the target acceleration is determined between state C10 and state C11. This is not indispensable. The target acceleration merely needs to be calculated after the rider starts pedaling the electric assist bicycle 1 in the certain pedaling manner, namely, in state C11 or thereafter. The target acceleration between state C10 and state C11 is defined by a rule different from the acceleration calculation rule 77a shown in FIG. 6. This rule is not directly related to the present invention and thus will not be described.

Between state C11 and state C12, the rider pedals the electric assist bicycle 1 in the certain pedaling manner (FIG. 9(d)). The vehicle speed is kept the same (FIG. 9(b), FIG. 9(f)), and the acceleration of the vehicle changes periodically (FIG. 9(c)).

State C12 is assumed to be a state where a headwind occurs (FIG. 9(a)). Usually, in the case in which the rider keeps on pedaling the electric assist bicycle with the same pedal force against the headwind, the trough of the waveform of the acceleration further drops (FIG. 9(c)) and the vehicle speed is decreased (FIG. 9(b)).

However, in state C12 and thereafter, the target acceleration calculation block 72 sets a target acceleration equivalent to the target acceleration between states C11 and C12 based on the pedal force generated by the certain pedaling manner. The motor electric current command value correction block 75 increases the assist power to be generated by the electric motor 53 such that the acceleration represented by the solid line in FIG. 9(e), not the acceleration represented by the dashed line, is obtained in state C12 and thereafter. With such an arrangement, even if the pedal force of the rider in state C12 and thereafter is equivalent to the pedal force of the rider between states C11 and C12, the vehicle speed is not decreased. The rider may maintain the vehicle speed by pedaling in the certain pedaling manner even if the headwind occurs. Namely, the rider may drive the electric assist bicycle 1 with the same sense of acceleration regardless of whether there is a headwind or not.

FIG. 10 shows waveforms of various signals when a load change occurs while the rider is pedaling the electric assist bicycle 1. The load change is assumed to be caused when the flat road is changed to a slope. The situation shown in FIG. 10 corresponds to FIG. 5B referred to above.

In each of FIG. 10(a) through FIG. 10(h), the horizontal axis represents the time. In FIG. 10(a), the vertical axis represents the magnitude of the load received by the electric assist bicycle 1 and the rider thereof. In FIG. 10(b), the vertical axis represents the vehicle speed in the travel direction of the vehicle. In state C12 and thereafter, FIG. 10(b) shows the vehicle speed in the case in which the process according to this preferred embodiment is not performed. In FIG. 10(c), the vertical axis represents the acceleration signal Gx in the x-axis direction that is output from the acceleration sensor 38. In state C12 and thereafter, FIG. 10(c) shows a waveform of the vehicle acceleration signal Gx in the x-axis direction in the case in which the control according to this preferred embodiment is not performed. In FIG. 10(d), the vertical axis represents the acceleration signal having a low-frequency component removed by the high-pass filter 73.

In FIG. 10(e), the vertical axis represents the torque signal that is output from the crank rotation sensor 42 in the case in which the process according to this preferred embodiment is not performed. By contrast, in FIG. 10(f), the vertical axis represents the torque signal that is output from the crank rotation sensor 42 in the case in which the process according to this preferred embodiment is performed. In FIG. 10(g), the vertical axis represents the target acceleration (solid line) determined from the torque signal shown in FIG. 10(f). It should be noted that this target acceleration does not include a signal component that is caused by the slope and is added to the output of the acceleration sensor 38. In FIG. 10(h), the vertical axis represents the vehicle speed (solid line) in the case in which the control according to this preferred embodiment is performed. For reference, FIG. 10(h) also shows, with the dashed line, a waveform of the vehicle speed in the x-axis direction in the case in which the control according to this preferred embodiment is not performed.

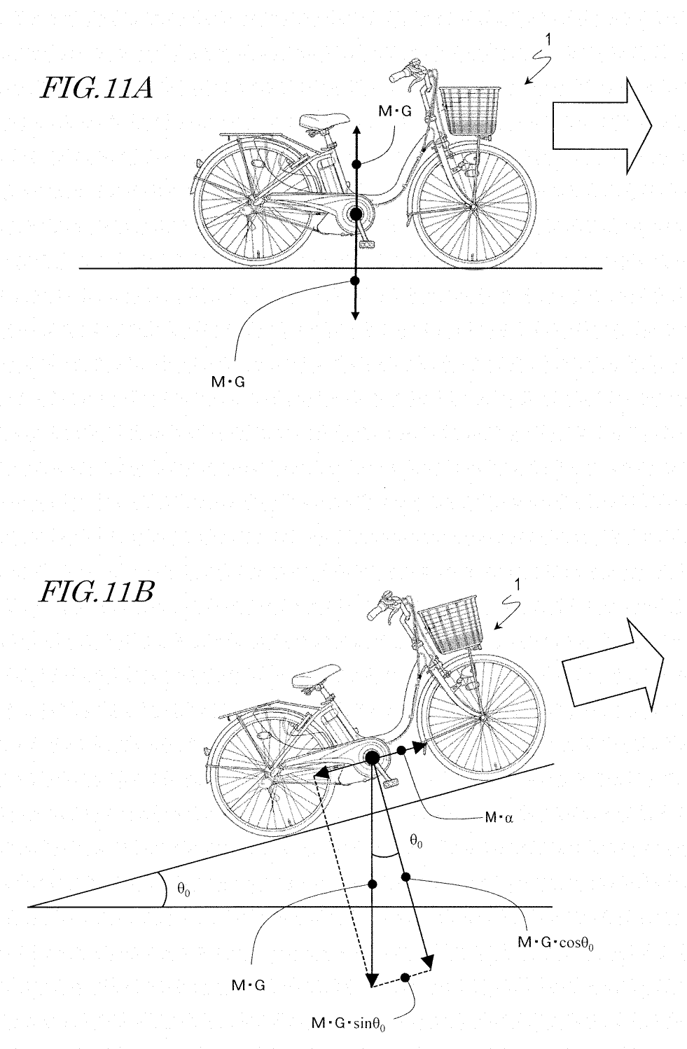

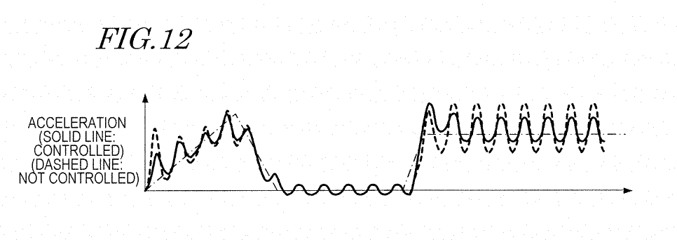

Now, with reference to FIGS. 11A and 11B, the relationship between the acceleration signal and the inclination will be described.

FIG. 11A is a static load correlation diagram of the electric assist bicycle 1 on a flat road. FIG. 11B is a static load correlation diagram of the electric assist bicycle 1 on a slope having an inclination angle θ. In FIGS. 11A and 11B, the mass of the electric assist bicycle 1 is represented by “M”, the gravitational acceleration is represented by “G”, the acceleration Gz in the X-axis direction is represented by “a”, and the inclination angle is represented by “00”.

FIG. 11A will be referred to. Where the electric assist bicycle 1 is the point mass that is present at the position of the gravitational center thereof, the gravitational force M·G is applied to the electric assist bicycle 1 in a vertically downward direction. The acceleration sensor 38 is constantly influenced by the gravitational force. Therefore, in the state where the electric assist bicycle 1 is still, the acceleration sensor 38 detects the gravitational acceleration G acting in the vertically downward direction (e.g., negative direction of the Z-axis direction).

In the state where the electric assist bicycle 1 is still, the electric assist bicycle 1 receives a drag M·G in a vertically upward direction from the ground, which counteracts the gravitational force M·G in the vertically downward direction. The electric assist bicycle 1 is in a still state against the gravitational force, and therefore, the electric assist bicycle 1 is accelerating upward, in which the gravitational acceleration is counteracted. Namely, the acceleration sensor 38 detects the acceleration G in the vertically upward direction (positive direction of the Z-axis direction).

The situation is the same in FIG. 11B. In the state of being still on a slope, the electric assist bicycle 1 is still against a component, of the gravitational force, in a direction going down the slope (against M·G·sin θ₀). Where the direction going down the slope is negative, the acceleration in this state is −G·sin θ₀. The electric assist bicycle 1 still on the slope is accelerating at a magnitude of G·sin θ₀ in a direction going up the slope so as to counteract the acceleration in the direction going down the slope (so as to counteract G·sin θ₀). Namely, the acceleration is +G·sin θ₀. Even after the electric assist bicycle 1 starts running in such a direction as to go up the slope, the acceleration +G·sin θ₀ is constantly overlapped.

FIG. 10 will be referred to again.

As shown in FIG. 10(c), the acceleration signal Gx includes a certain offset in state C12 and thereafter. A reason for this is that the above-described acceleration of +G·sin θ₀ is overlapped. The high-pass filter 73 removes the overlapped offset component +G·sin θ₀. The motor electric current command value correction block 75 determines a deviation between the acceleration signal (FIG. 10(d)) that is output from the high-pass filter 73 and the target acceleration (FIG. 10(g)), in the travel direction of the vehicle, that is determined from the torque signal (FIG. 10(f)). The motor electric current command value correction block 75 adjusts the motor torque (assist power) to be generated by the electric motor 53 such that the deviation is decreased. Hereinafter, this will be described specifically.

First, states C10 through C12 are the same as states C10 through C12 described above with reference to FIG. 9 and thus will not be described. Between states C11 and C12, the rider pedals the electric assist bicycle 1 in the certain pedaling manner (FIG. 10(d)). The vehicle speed is constant (FIG. 10(b), FIG. 10(f)) and the vehicle acceleration changes periodically (FIG. 10(c)).

State C12 is a state where the flat road is changed to the slope (FIG. 10(a)). Usually, in the case in which the rider keeps on pedaling the electric assist bicycle on the slope with the same pedal force, the trough of the waveform of the acceleration further drops (FIG. 10(c)) and the vehicle speed is decreased (FIG. 10(b)).

When the electric assist bicycle 1 starts running on the slope, the rider intuitively increases the pedal force. This is understood because the torque signal is increased immediately after state C12 in FIG. 19(f) and then is gradually decreased.

The target acceleration calculation block 72 calculates the target acceleration based on the pedal force (torque signal). The motor electric current command value calculation block 74 calculates the motor electric current command value based on the selected assist mode, the pedal torque and the transmission gear range.

The motor electric current command value correction block 75 determines the deviation between the target acceleration calculated by the target acceleration calculation block 72 and the current acceleration that is output from the high-pass filer 73. The motor electric current command value correction block 75 uses the process represented by expression 1 shown above to determine the magnitude of the motor torque to be generated by the electric motor 53 such that the obtained deviation is decreased. The determined motor torque is larger than the motor torque while the electric assist bicycle 1 is running on the flat road. The motor electric current command value is corrected such that such a torque is generated, and the motor electric current command value is further corrected by the motor electric current command value correction block 76. With such an arrangement, even if the pedal force of the rider in state C12 and thereafter is equivalent to the pedal force of the rider between states C11 and C12, the vehicle speed is maintained (FIG. 10(h)). The rider may maintain the vehicle speed by pedaling in the certain pedaling manner even while going up the slope. Namely, the rider may drive the electric assist bicycle 1 with the same sense of acceleration regardless of whether there is a slope or not.

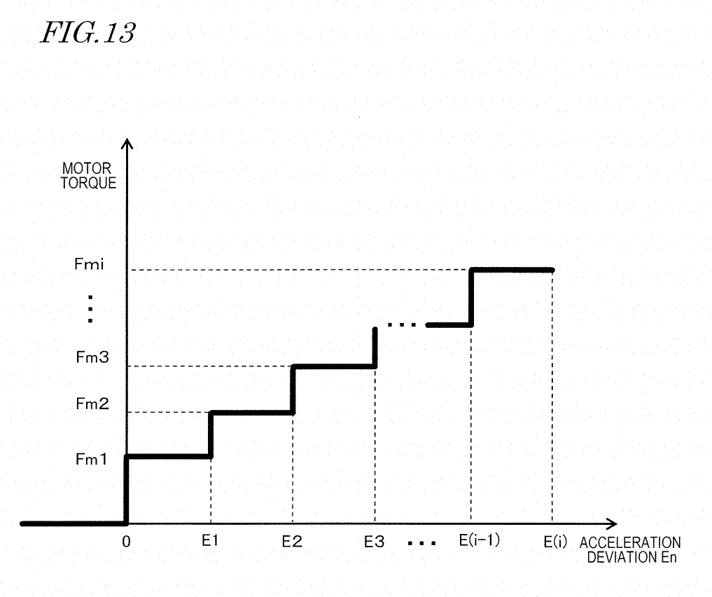

FIG. 12 shows the acceleration signal as a target for the case in which the low-frequency component is not removed by the high-pass filter 73 (solid line). FIG. 12 also shows the acceleration signal in the case in which the process according to this preferred embodiment is not performed (dashed line).

In the above-described process, the acceleration signal having the low-frequency component removed by the high-pass filter 73 is used. However, the result is the same even in the case in which the target acceleration value is set as represented by the solid line in FIG. 12. The use of the high-pass filter 73 realizes the same process as that in the case in which the headwind or the like occurs, regardless of whether the electric assist bicycle 1 is running on a slope or not.

In the above, the motor electric current command value correction block 75 is described as determining the motor torque by use of expression 1. In another example, the motor electric current command value correction block 75 may determine the motor torque in accordance with the magnitude of the deviation En in the acceleration.

FIG. 13 shows a motor torque in accordance with the magnitude of the deviation in the acceleration. According to this table, the motor torque Fm may be determined in accordance with the value of the deviation En in the acceleration. More specifically, when En<0, the motor torque Fm=0, when 0≤En<E1, Fm=Fm1, when E1≤En<E2, Fm=Fm2, . . . when E(i−1)≤En<E(i), Fm=Fmi.

The above-described two types of methods for determining the motor torque are examples and do not limit the present invention.

In the above-described example, while there is a headwind and while the electric assist bicycle 1 is going up a slope, the controller 70 increases the assist power to be generated by the electric motor 53. By contrast, in the case in which the rider rotates the pedal 55 with a smaller torque when there is a tailwind or while the electric assist bicycle 1 is going down the slope, the target acceleration is decreased. Therefore, the motor electric current command value correction block 75 of the controller 70 decreases the assist power to be generated by the electric motor 53. The above-described process is applicable to the case in which the load applied to the electric assist bicycle 1 and the rider thereof is decreased, as well as to the case in which a heavy load is applied to the electric assist bicycle 1 and the rider thereof.

Some preferred embodiments of the present invention have been described. The above description of the preferred embodiments provides an illustrative example of the present invention, but does not limit the present invention. A preferred embodiment in which elements described in the above-described preferred embodiments are combined appropriately may be provided. The elements may be, for example, modified, replaced, added or deleted within the scope of the claims of the present invention and equivalents thereof.

As described above, an illustrative electric assist system (driving unit 51) according to a preferred embodiment of the present invention is usable for an electric assist vehicle (electric assist bicycle 1) including the pedal 55. The electric assist system includes the crankshaft 57 rotatable by human power of a rider applied to the pedal; the torque sensor 41 that outputs a torque signal in accordance with a magnitude of a torque generated at the crankshaft; the electric motor 53 that generates an assist power that assists the human power of the rider; the acceleration sensor 38 that outputs an acceleration signal in accordance with a current acceleration in a travel direction of the electric assist vehicle; and the controller 70 configured or programmed to receive the torque signal and the acceleration signal and determine a magnitude of the assist power to be generated by the electric motor. The controller calculates a target acceleration from the torque signal based on a rule prepared in advance, and determines the magnitude of the assist power to be generated by the electric motor such that a deviation between the target acceleration and the current acceleration is decreased.

Because of the structure of the bicycle that allows the rider to have his/her foot step on, and rotate, the pedal, the magnitude of the human power of the rider applied to the pedal changes in accordance with the position of the pedal while the rider is rotating the pedal. Therefore, the acceleration in the travel direction of the electric assist bicycle changes in accordance with the position of the pedal while the rider is rotating the pedal. The electric assist system changes the magnitude of the assist power to be generated by the electric motor such that the deviation between the target acceleration determined from the pedal force of the rider and the current acceleration of the vehicle is decreased. Even if a load is applied during running, the pedal force of the rider is considered to represent the sense of acceleration desired by the rider. Therefore, the target acceleration is set based on the pedal force, and the current acceleration of the vehicle is controlled to be made closer to the target acceleration. With such an arrangement, the rider may run the electric assist vehicle with an appropriate magnitude of assist power in accordance with the load during running.

In a preferred embodiment of the present invention, the controller 70 is configured or programmed to perform PID control to determine the magnitude of the assist power to be generated by the electric motor 53 and thus to decrease the deviation.

In a preferred embodiment of the present invention, where a current deviation at current time t is represented as E(t), and feedback gains of a proportional element, a differential element and an integration element of the assist power control system are respectively represented as Kp, Kd and Ki, the controller 70 may determine a motor torque Fm, corresponding to the assist power to be generated by the electric motor 53, by the following expression:

$$Fm ( t ) = Kp \times e ( t ) + Ki \times {\int }_{0}^{t} e ( τ ) d τ + Kd \times \frac{de ( t )}{dt} . \qquad Expression 1$$

In a preferred embodiment of the present invention, the controller 70 may determine the magnitude of the assist power to be generated by the electric motor 53 such that the deviation is made closer to 0.

In any of the above-described preferred embodiments, the ability to make the acceleration closer to the target acceleration may be improved.

In a preferred embodiment of the present invention, the controller 70 is configured or programmed to store, in advance, a table associating a command value of an electric current that is to flow in the electric motor 53 and a magnitude of a motor torque corresponding to the assist power to be generated by the electric motor to each other, and refer to the table to determine the command value of the electric current required to generate the motor torque.

In a preferred embodiment of the present invention, the controller 70 is configured or programmed to store, in advance, a table associating a command value of an electric current that is to flow in the electric motor 53 and a magnitude of a motor torque to each other for each of ranges of magnitudes of the deviation, and refer to the table to determine the command value of the electric current required to generate the motor torque.

In a preferred embodiment of the present invention, where a current deviation at current time t is represented as E(t), and feedback gains usable to determine a command value of an electric current from a proportion term, an integration term and a differential term regarding a residual deviation are respectively represented as Kp′, Kd′ and Ki′, the controller 70 is configured or programmed to determine the command value Im, of the electric current that is to flow in the electric motor, by the following expression:

$$Im ( t ) = {Kp}^{′} \times e ( t ) + {Ki}^{′} \times {\int }_{0}^{t} e ( τ ) d τ + {Kd}^{′} \times \frac{de ( t )}{dt} . \qquad Expression 2$$

In a preferred embodiment of the present invention, the controller 70 includes the storage 77 that stores the rule prepared in advance.

In a preferred embodiment of the present invention, the rule may be a map or a function defining the correspondence between the torque signal and the target acceleration.

In a preferred embodiment of the present invention, the function may be a nonlinear function or a linear function.

In a preferred embodiment of the present invention, the controller 70 includes the high-pass filter 73 that transmits a high-frequency component of a predefined frequency or higher that is included in the received acceleration signal.

In a preferred embodiment of the present invention, the controller 70 includes the high-pass filter 73 that transmits a high-frequency component of 5 Hz or higher.

The high-pass filter 73 may be provided so that the acceleration generated by the rider rotating the pedal 55 is appropriately extracted.

In a preferred embodiment of the present invention, during a time period in which the rider rotates the pedal 55 to make one rotation of the crankshaft 57, the torque sensor 41 and the acceleration sensor 38 respectively output a torque signal and an acceleration signal a plurality of times or continuously, and the controller 70 is configured or programmed to determine the magnitude of the assist power to be generated by the electric motor 53 a plurality of times or temporally continuously.

In a preferred embodiment of the present invention, during a time period in which the rider rotates the pedal 55 to make one rotation of the crankshaft 57, the torque signal changes in accordance with the rotation of the crankshaft that is associated with an operation of the rider rotating the pedal, the acceleration signal changes in accordance with the operation of the rider rotating the pedal and an external disturbance applied to the electric assist vehicle (electric assist bicycle 1), and the controller 70, at a predefined timing, is configured or programmed to calculate the target acceleration from the torque signal, calculate the acceleration from the acceleration signal, and determine the magnitude of the assist power to be generated by the electric motor 53.

In a preferred embodiment of the present invention, the electric assist system (driving unit 51) further includes the motor driving circuit 79 that outputs, to the electric motor, an electric current including at least one of an amplitude, a frequency and a flow direction controlled in accordance with a command value. The controller 70 is configured or programmed to output, to the motor driving circuit 79, a command value to cause an electric current that is in accordance with the determined magnitude of the assist power to flow. With such an arrangement, an appropriate magnitude of assist power may be generated such that the target acceleration in accordance with the pedal force during running is obtained.

An electric assist vehicle (electric assist bicycle 1) according to an illustrative preferred embodiment of the present invention includes the above-described electric assist system (driving unit 51). In a preferred embodiment of the present invention, the electric assist vehicle includes the front wheel 25 and the rear wheel 26; and the power transmission mechanism 31 that transmits the human power of the rider and the assist power to the rear wheel. The electric assist vehicle including the electric assist system according to an illustrative preferred embodiment of the present invention may generate an appropriate magnitude of assist power such that the target acceleration in accordance with the pedal force during running is obtained.

Preferred embodiments of the present invention are especially useful for a vehicle that includes an acceleration sensor and is driven by human power assisted by assist power, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric assist system for an electric assist vehicle including a pedal, the electric assist system comprising:
a crankshaft rotatable by human power of a rider applied to the pedal;
a torque sensor that outputs a torque signal in accordance with a magnitude of a torque generated at the crankshaft;
an electric motor that generates an assist power that assists the human power of the rider;
an acceleration sensor that outputs an acceleration signal in accordance with a current acceleration in a travel direction of the electric assist vehicle; and
a controller configured or programmed to receive the torque signal and the acceleration signal and to determine a magnitude of the assist power to be generated by the electric motor; wherein
the controller is configured or programmed to calculate a target acceleration from the torque signal based on a rule prepared in advance, and to determine the magnitude of the assist power to be generated by the electric motor such that a deviation between the target acceleration and the current acceleration is decreased.

2. The electric assist system of claim 1, wherein the controller is configured or programmed to perform PID control to determine the magnitude of the assist power to be generated by the electric motor to decrease the deviation.

3. The electric assist system of claim 2, wherein
when a current deviation at a current time t is represented as E(t), and feedback gains of a proportional element, a differential element, and an integration element of the assist power control system are respectively represented as Kp, Kd, and Ki, the controller is configured or programmed to determine a motor torque Fm, corresponding to the assist power to be generated, by the electric motor by:
$$Fm ( t ) = Kp \times e ( t ) + Ki \times {\int }_{0}^{t} e ( τ ) d τ + Kd \times \frac{de ( t )}{dt} . \qquad Expression 1$$

4. The electric assist system of claim 1, wherein the controller is configured or programmed to determine the magnitude of the assist power to be generated by the electric motor such that the deviation is closer to 0.

5. The electric assist system of claim 1, wherein the controller is configured or programmed to store, in advance, a table associating a command value of an electric current in the electric motor and a magnitude of a motor torque corresponding to the assist power to be generated by the electric motor to each other, and to refer to the table to determine the command value of the electric current required to generate the motor torque.

6. The electric assist system of claim 4, wherein the controller is configured or programmed to store, in advance, a table associating a command value of an electric current in the electric motor and a magnitude of a motor torque to each other for each of ranges of magnitudes of the deviation, and to refer to the table to determine the command value of the electric current required to generate the motor torque.

7. The electric assist system of claim 2, wherein
when a current deviation at current time t is represented as E(t), and feedback gains usable to determine a command value of an electric current from a proportion term, a differential term and an integration term regarding a residual deviation are respectively represented as Kp′, Kd′ and Ki′, the controller is configured or programmed to determine the command value Im, of the electric current in the electric motor, by:
$$Im ( t ) = {Kp}^{′} \times e ( t ) + {Ki}^{′} \times {\int }_{0}^{t} e ( τ ) d τ + {Kd}^{′} \times \frac{de ( t )}{dt} . \qquad Expression 2$$

8. The electric assist system of claim 1, wherein the controller includes a storage that stores the rule prepared in advance.

9. The electric assist system of claim 8, wherein the rule is a map or a function defining correspondence between the torque signal and the target acceleration.

10. The electric assist system of claim 9, wherein the function is a nonlinear function or a linear function.

11. The electric assist system of claim 1, wherein the controller includes a high-pass filter that transmits a high-frequency component of a predefined frequency or higher included in the acceleration signal.

12. The electric assist system of claim 11, wherein the controller includes a high-pass filter that transmits a high-frequency component of 5 Hz or higher.

13. The electric assist system of claim 1, wherein
during a time period in which the rider rotates the pedal to make one rotation of the crankshaft; the torque sensor and the acceleration sensor respectively output the torque signal and the acceleration signal a plurality of times or continuously; and
the controller is configured or programmed to determine the magnitude of the assist power to be generated by the electric motor a plurality of times or temporally continuously.

14. The electric assist system of claim 13, wherein
during a time period in which the rider rotates the pedal to make one rotation of the crankshaft, the torque signal changes in accordance with the rotation of the crankshaft that is associated with an operation of the rider rotating the pedal;
the acceleration signal changes in accordance with the operation of the rider rotating the pedal and an external disturbance applied to the electric assist vehicle; and
the controller, at a predefined timing, is configured or programmed to calculate the target acceleration from the torque signal, calculate the acceleration from the acceleration signal, and determine the magnitude of the assist power to be generated by the electric motor.

15. The electric assist system of claim 1, further comprising:
a motor driving circuit that outputs, to the electric motor, an electric current including at least one of an amplitude, a frequency, and a flow direction controlled in accordance with a command value; wherein
the controller is configured or programmed to output, to the motor driving circuit, a command value to provide an electric current that is in accordance with the determined magnitude of the assist power.

16. An electric assist vehicle comprising the electric assist system of claim 15.

17. The electric assist vehicle of claim 16, further comprising:
a front wheel and a rear wheel; and
a power transmission mechanism that transmits the human power of the rider and the assist power to the rear wheel.
